(19) United States
(12) Patent Application Publication
(10) Pub. No.: US 2026/0072519 A1
(43) Pub. Date: Mar. 12, 2026

(54) EXTENDED REALITY USER INTERFACES

(71) Applicant: Snap Inc., Santa Monica, CA (US)

(72) Inventors: Viktoria Hwang, Monrovia, CA (US); James Powderly, Venice, CA (US); Karen Stolzenberg, Venice, CA (US); Mathieu Emmanuel Vignau, Los Angeles, CA (US)

(21) Appl. No.: 18/883,767

(22) Filed: Sep. 12, 2024

(51) Int. Cl. G06F 3/01; G02B 27/01; G06T 7/70; G06T 17/20; G06V 40/10; G06V 40/20

(52) U.S. Cl. CPC G06F 3/017; G02B 27/0101; G02B 27/017; G06F 3/011; G06T 7/70; G06T 17/20; G06V 40/10; G06V 40/28; G02B 2027/0138; G02B 2027/014; G06T 2200/24; G06T 2207/30196

(57) ABSTRACT

An extended Reality (XR) system is provided for providing a user interface in an XR environment. The XR system detects a position and an orientation of a hand of a user. The XR system determines a user view of the hand using the detected position and orientation. In response to determining the user view is of a dorsal surface of the hand, the XR system causes display of a hand-centric user interface using a set of dorsal surface user interface elements. In response to determining the user view is of a palmar surface of the hand, the XR system causes display of the hand-centric user interface using a set of palmar user interface elements. The XR system detects, using the set of tracking sensors, a user input based on an interaction with the hand-centric user interface. The XR system then performs an action based on the detected user input.

### TECHNICAL FIELD

The present disclosure relates generally to user interfaces and, more particularly, to user interfaces used for extended reality.

### BACKGROUND

A head-wearable apparatus can be implemented with a transparent or semi-transparent display through which a user of the head-wearable apparatus can view the surrounding environment. Such head-wearable apparatuses enable a user to see through the transparent or semi-transparent display to view the surrounding environment, and to also see objects (e.g., objects such as a rendering of a 2D or 3D graphic model, images, video, text, and so forth) that are generated for display to appear as a part of, and/or overlaid upon, the surrounding environment. This is typically referred to as “augmented reality” or “AR.” A head-wearable apparatus can additionally completely occlude a user's visual field and display a virtual environment through which a user can move or be moved. This is typically referred to as “virtual reality” or “VR.” In a hybrid form, a view of the surrounding environment is captured using cameras, and then that view is displayed along with augmentation to the user on displays the occlude the user's eyes. As used herein, the term extended Reality (XR) refers to augmented reality, virtual reality and any of hybrids of these technologies unless the context indicates otherwise.

A user of the head-wearable apparatus can access and use a computer software application to perform various tasks or engage in an activity. To use the computer software application, the user interacts with a user interface provided by the head-wearable apparatus.

### BRIEF DESCRIPTION OF THE SEVERAL VIEWS OF THE DRAWINGS

In the drawings, which are not necessarily drawn to scale, like numerals can describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1A is a perspective view of a head-wearable apparatus, according to some examples.

FIG. 1B illustrates a further view of the head-wearable apparatus of FIG. 1A, according to some examples.

FIG. 2 is a diagrammatic representation of a machine in the form of a computer system, according to some examples.

FIG. 3 is a block diagram showing a software architecture, according to some examples.

FIG. 4 illustrates a system in which the head-wearable apparatus is operably connected to a mobile device, according to some examples.

FIG. 5 illustrates a networked environment, according to some examples.

FIG. 6 illustrates a collaboration diagram of components of an XR system, according to some examples.

FIG. 7 illustrates a hand-centric user interface method for providing a user interface in an XR system, according to some examples.

FIG. 8 illustrates a dorsal hand-centric user interface, according to some examples.

FIG. 9 illustrates a palmar hand-centric user interface, according to some examples.

FIG. 10 illustrates another palmar hand-centric user interface, according to some examples.

FIG. 11 illustrates an ulnar hand-centric user interface 1100, according to some examples.

FIG. 12A, FIG. 12B, and FIG. 12C illustrate an orientation-adaptive palmar hand-centric user interface, according to some examples.

FIG. 13 illustrates another palmar hand-centric user interface, according to some examples.

FIG. 14 illustrates an in-application system user interface sequence, according to some examples.

FIG. 15 illustrates another in-application system user interface sequence, according to some examples.

FIG. 16A illustrates a machine-learning pipeline, according to some examples.

FIG. 16B illustrates training and use of a machine-learning program, according to some examples.

### DETAILED DESCRIPTION

Extended reality (XR) systems that combine virtual and real-world elements face challenges in providing intuitive and efficient user interfaces. Traditional input methods like keyboards are often impractical in XR environments, requiring new approaches for user interaction. Additionally, displaying virtual content in XR can be problematic, as fixed user interface element may obstruct the user's view of the real world or fail to adapt to the user's changing perspective and environment.

Existing XR interfaces frequently struggle to seamlessly integrate multiple input modalities like voice, gestures, and touch in a cohesive manner. This can lead to a fragmented user experience as users switch between different interaction paradigms. Furthermore, many XR systems lack effective ways to transition between different types of user interfaces, such as those optimized for close interaction versus those designed for viewing content at a distance. These limitations can hinder the usability and adoption of XR technologies across a range of applications.

The methodologies described in this disclosure address these problems through several approaches. In some examples, an XR system provides a hand-centric user interface located on the user's hand, allowing for intuitive and natural interactions without the need for traditional input devices.

In some examples, the XR system uses tracking sensors to detect the position and orientation of the user's hand, allowing for the dynamic display of user interface elements on a dorsal surface and a palmar surface of a user's hand. This adaptive approach enables the XR system to present relevant information and controls based on the user's current hand orientation and view, addressing the challenge of transitioning between different types of interfaces.

In some examples, to overcome the limited physical space available on the hand, the XR system employs techniques such as finger pinches, taps, and gestures to expand functionality without cluttering the interface.

In some examples, the use of UV mapping and dynamic texture rendering allows a hand-centric user interface to conform to the hand's surface, creating a “tattoo-like” effect that moves naturally with the user's hand. This approach provides a consistent and easily accessible system navigation across different XR experiences and applications.

In some examples, the system also addresses visual comfort issues by adjusting the size, position, and density of user interface elements based on factors such as the focal plane of the XR display device and the user's hand size.

In some examples, an XR system detects, using a set of tracking sensors, a position and an orientation of a hand of a user. The XR system determines a user view of the hand using the detected position and orientation. In response to determining the user view is of a dorsal surface of the hand, the XR system causes display of a hand-centric user interface using a set of dorsal surface user interface elements. In response to determining the user view is of a palmar surface of the hand, the XR system causes display of the hand-centric user interface using a set of palmar user interface elements. The XR system detects, using the set of tracking sensors, a user input based on an interaction with the hand-centric user interface and performs an action based on the detected user input.

In some examples, the XR system causes display of the hand-centric user interface by generating a three-dimensional (3D) mesh of the hand based on the detected position and orientation, dynamically rendering a set of user interface elements as a texture, and applying the rendered texture to the 3D mesh of the hand to display the hand-centric user interface.

In some examples, applying the rendered texture to the 3D mesh can include using UV mapping to wrap the texture around the 3D mesh of the hand.

In some examples, the XR system can detect changes in the position or orientation of the hand and dynamically update the rendered texture on the 3D mesh to maintain the hand-centric user interface in response to the detected changes.

In some examples, interaction with a hand-centric user interface can include at least one of a finger pinch, a hand touch, or a finger tap.

By implementing these methodologies, the XR system can offer a more intuitive, comfortable, and versatile user interface solution that adapts to the unique challenges of XR environments.

Other technical features can be readily apparent to one skilled in the art from the following figures, descriptions, and claims.

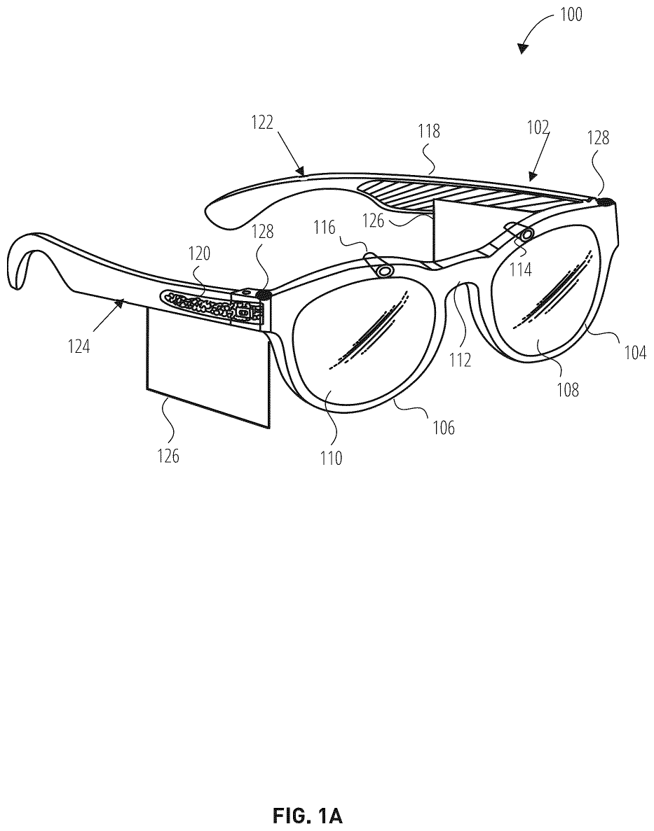

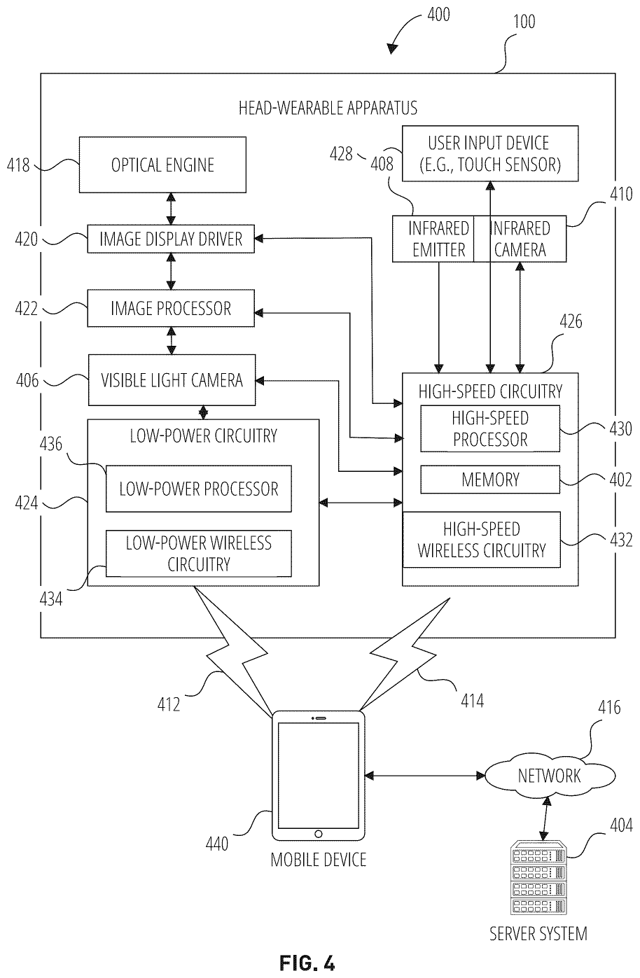

FIG. 1A is a perspective view of a head-wearable apparatus 100 according to some examples. The head-wearable apparatus 100 can be a client device of an XR system, such as a user system 502 of FIG. 5. The head-wearable apparatus 100 can include a frame 102 made from any suitable material such as plastic or metal, including any suitable shape memory alloy. In some examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the head-wearable apparatus 100.

The frame 102 additionally includes a left arm or left temple piece 122 and a right arm or right temple piece 124. In some examples, the frame 102 can be formed from a single piece of material so as to have a unitary or integral construction.

The head-wearable apparatus 100 can include a computing device, such as a computer 120, which can be of any suitable type so as to be carried by the frame 102 and, in one or more examples, of a suitable size and shape, so as to be partially disposed in one of the left temple piece 122 or the right temple piece 124. The computer 120 can include one or more processors with memory, wireless communication circuitry, and a power source. As discussed below, the computer 120 includes low-power circuitry 424, high-speed circuitry 426, and a display processor. Various other examples can include these elements in different configurations or integrated together in different ways. Additional details of aspects of the computer 120 can be implemented as illustrated by the machine 200 discussed herein.

The computer 120 additionally includes a battery 118 or other suitable portable power supply. In some examples, the battery 118 is disposed in left temple piece 122 and is electrically coupled to the computer 120 disposed in the right temple piece 124. The head-wearable apparatus 100 can include a connector or port (not shown) suitable for charging the battery 118, a wireless receiver, transmitter or transceiver (not shown), or a combination of such devices.

The head-wearable apparatus 100 includes a first or left camera 114 and a second or right camera 116. Although two cameras are depicted, other examples contemplate the use of a single or additional cameras (e.g., two or more cameras).

In some examples, the head-wearable apparatus 100 includes any number of input sensors or other input/output devices in addition to the left camera 114 and the right camera 116. Such sensors or input/output devices can additionally include biometric sensors, location sensors, motion sensors, and so forth.

In some examples, the left camera 114 and the right camera 116 provide tracking image data for use by the head-wearable apparatus 100 to extract 3D information from a real-world scene.6

The head-wearable apparatus 100 can also include a set of touchpads 126 mounted to or integrated with one or both of the left temple piece 122 and right temple piece 124. The touchpad 126 is generally vertically-arranged, approximately parallel to a user's temple in some examples. As used herein, generally vertically aligned means that the touchpad is more vertical than horizontal, although potentially more vertical than that. Additional user input can be provided by a set of buttons 128, which in the illustrated examples are provided on the outer upper edges of the left optical element holder 104 and right optical element holder 106. The touchpads 126 and buttons 128 provide a means whereby the head-wearable apparatus 100 can receive input from a user of the head-wearable apparatus 100.

FIG. 1B illustrates the head-wearable apparatus 100 from the perspective of a user while wearing the head-wearable apparatus 100. For clarity, a number of the elements shown in FIG. 1A have been omitted. As described in FIG. 1A, the head-wearable apparatus 100 shown in FIG. 1B includes left optical element 140 and right optical element 144 secured within the left optical element holder 132 and the right optical element holder 136 respectively.

The head-wearable apparatus 100 includes right forward optical assembly 130 including a left near eye display 150, a right near eye display 134, and a left forward optical assembly 142 including a left projector 146 and a right projector 152.

In some examples, the near eye displays are waveguides. The waveguides include reflective or diffractive structures (e.g., gratings and/or optical elements such as mirrors, lenses, or prisms). Light 138 emitted by the right projector 152 encounters the diffractive structures of the waveguide of the right near eye display 134, which directs the light towards the right eye of a user to provide an image on or in the right optical element 144 that overlays the view of the real-world scene seen by the user. Similarly, light 148 emitted by the left projector 146 encounters the diffractive structures of the waveguide of the left near eye display 150, which directs the light towards the left eye of a user to provide an image on or in the left optical element 140 that overlays the view of the real-world scene seen by the user. The combination of a Graphical Processing Unit, an image display driver, the right forward optical assembly 130, the left forward optical assembly 142, left optical element 140, and the right optical element 144 provide an optical engine of the head-wearable apparatus 100. The head-wearable apparatus 100 uses the optical engine to generate an overlay of the real-world scene view of the user including display of a user interface to the user of the head-wearable apparatus 100.

It will be appreciated however that other display technologies or configurations can be utilized within an optical engine to display an image to a user in the user's field of view. For example, instead of a projector and a waveguide, an LCD, LED or other display panel or surface can be provided.

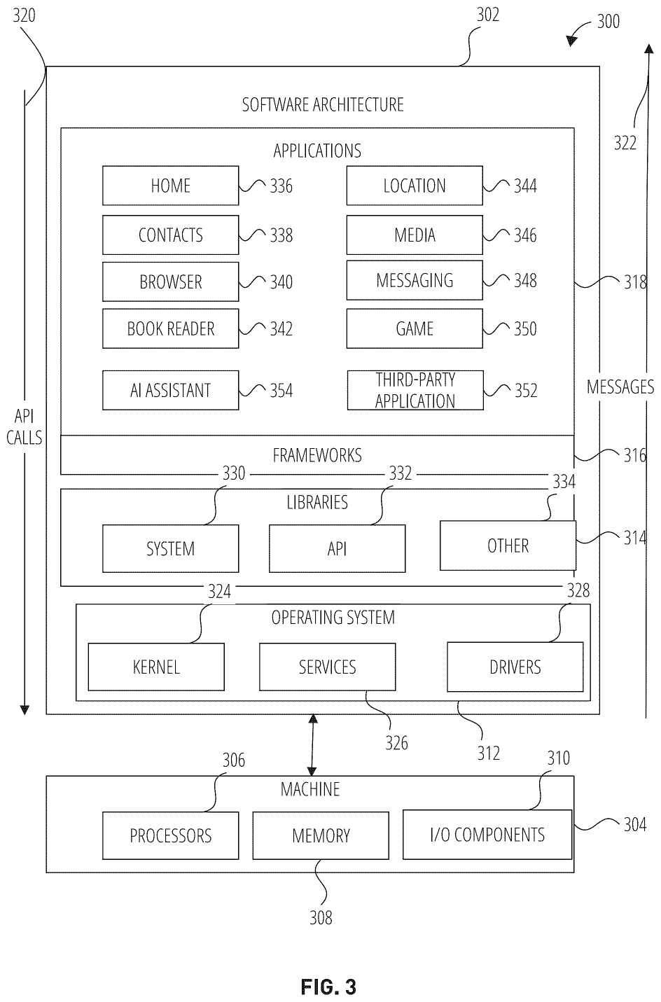

In use, a user of the head-wearable apparatus 100 will be presented with information, content and various user interfaces on the near eye displays. As described in more detail herein, the user can then interact with the head-wearable apparatus 100 using a touchpad 126 and/or the button 128, voice inputs or touch inputs on an associated device (e.g. mobile device 440 illustrated in FIG. 4), and/or hand movements, locations, and positions recognized by the head-wearable apparatus 100.

In some examples, an optical engine of an XR system is incorporated into a lens that is in contact with a user's eye, such as a contact lens or the like. The XR system generates images of an XR experience using the contact lens.

In some examples, the head-wearable apparatus 100 includes an XR system. In some examples, the head-wearable apparatus 100 is a component of an XR system including additional computational components. In some examples, the head-wearable apparatus 100 is a component in an XR system including additional user input systems or devices.

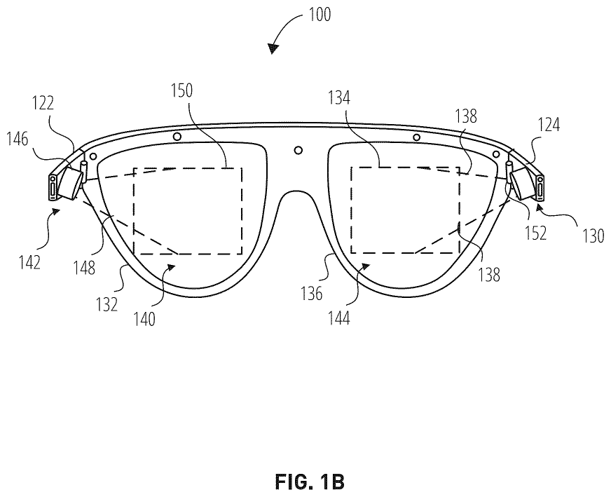

FIG. 2 is a diagrammatic representation of the machine 200 within which instructions 202 (e.g., software, a program, an application, an applet, an app, or other executable code) for causing the machine 200 to perform any one or more of the methodologies discussed herein can be executed. For example, the instructions 202 can cause the machine 200 to execute any one or more of the methods described herein. The instructions 202 transform the general, non-programmed machine 200 into a particular machine 200 programmed to carry out the described and illustrated functions in the manner described. The machine 200 can operate as a standalone device or can be coupled (e.g., networked) to other machines. In a networked deployment, the machine 200 can operate in the capacity of a server machine or a client machine in a server-client network environment, or as a peer machine in a peer-to-peer (or distributed) network environment. The machine 200 can include, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 202, sequentially or otherwise, that specify actions to be taken by the machine 200. Further, while a single machine 200 is illustrated, the term “machine” shall also be taken to include a collection of machines that individually or jointly execute the instructions 202 to perform any one or more of the methodologies discussed herein. The machine 200, for example, can include the user system 502 or any one of multiple server devices forming part of the server system 510. In some examples, the machine 200 can also include both client and server systems, with certain operations of a particular method or algorithm being performed on the server-side and with certain operations of the method or algorithm being performed on the client-side.

The machine 200 can include one or more hardware processors 204, memory 206, and input/output I/O components 208, which can be configured to communicate with each other via a bus 210.

The processor 204 can include one or more processors such as, but not limited to, processor 212 and processor 214. The one or more processors can include one or more types of processing systems such as, but not limited to, Central Processing Units (CPUs), Graphics Processing Units (GPUs), Digital Signal Processors (DSPs), Neural Processing Units (NPUs) or Artificial Intelligence (AI) Accelerators, Physics Processing Units (PPUs), Field-Programmable Gate Arrays (FPGAs), Multi-core Processors, Symmetric Multiprocessing (SMP) Systems, and the like.

The memory 206 includes a main memory 216, a static memory 218, and a storage unit 220, both accessible to the processor 204 via the bus 210. The main memory 206, the static memory 218, and storage unit 220 store the instructions 202 embodying any one or more of the methodologies or functions described herein. The instructions 202 can also reside, completely or partially, within the main memory 216, within the static memory 218, within machine-readable medium 222 within the storage unit 220, within at least one of the processor 204 (e.g., within the processor's cache memory), or any suitable combination thereof, during execution thereof by the machine 200.

The I/O components 208 can include a wide variety of components to receive input, provide output, produce output, transmit information, exchange information, capture measurements, and so on. The specific I/O components 208 that are included in a particular machine will depend on the type of machine. For example, portable machines such as mobile phones can include a touch input device or other such input mechanisms, while a headless server machine will likely not include such a touch input device. It will be appreciated that the I/O components 208 can include many other components that are not shown in FIG. 2. In various examples, the I/O components 208 can include user output components 224 and user input components 226. The user output components 224 can include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 226 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 208 can include biometric components 228, motion components 230, environmental components 232, or position components 234, among a wide array of other components. For example, the biometric components 228 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

### Example Types of BMI Technologies, Including:

Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request, and in accordance with applicable laws. Further, such biometric data can be used for very limited purposes, such as identification verification. To ensure limited and authorized use of biometric information and other Personally Identifiable Information (PII), access to this data is restricted to authorized personnel only, if at all. Any use of biometric data can strictly be limited to identification verification purposes, and the data is not shared or sold to any third party without the explicit consent of the user. In addition, appropriate technical and organizational measures are implemented to ensure the security and confidentiality of this sensitive information.

The motion components 230 include acceleration sensor components (e.g., accelerometer), gravitation sensor components, rotation sensor components (e.g., gyroscope).

The environmental components 232 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that can provide indications, measurements, or signals corresponding to a surrounding physical environment.

With respect to cameras, the user system 502 can have a camera system including, for example, front cameras on a front surface of the user system 502 and rear cameras on a rear surface of the user system 502. The front cameras can, for example, be used to capture still images and video of a user of the user system 502 (e.g., “selfies”), which can then be modified with digital effect data (e.g., filters, media augmentation, overlays, XR effects, and the like) described below. The rear cameras can, for example, be used to capture still images and videos in a more traditional camera mode, with these images similarly being modified with digital effect data. In addition to front and rear cameras, the user system 502 can also include a 360° camera for capturing 360° photographs and videos.

Moreover, the camera system of the user system 502 can be equipped with advanced multi-camera configurations. This can include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 502 can also feature triple, quad, or even penta camera configurations on both the front and rear sides of the user system 502. These multiple cameras systems can include a wide camera, an ultra-wide camera, a telephoto camera, a macro camera, and a depth sensor, for example.

Communication can be implemented using a wide variety of technologies. The I/O components 208 further include communication components 236 operable to couple the machine 200 to a Network 238 or devices 240 via respective coupling or connections. For example, the communication components 236 can include a network interface component or another suitable device to interface with the Network 238. In further examples, the communication components 236 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 240 can be another machine or any of a wide variety of peripheral devices (e.g., a peripheral device coupled via a USB).

Moreover, the communication components 236 can detect identifiers or include components operable to detect identifiers. For example, the communication components 236 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information can be derived via the communication components 236, such as location via Internet Protocol (IP) geolocation, location via Wi-Fi® signal triangulation, location via detecting an NFC beacon signal that can indicate a particular location, and so forth.

The various memories (e.g., main memory 216, static memory 218, and memory of the processor 204) and storage unit 220 can store one or more sets of instructions and data structures (e.g., software) embodying or used by any one or more of the methodologies or functions described herein. These instructions (e.g., the instructions 202), when executed by processor 204, cause various operations to implement the disclosed examples.

The instructions 202 can be transmitted or received over the Network 238, using a transmission medium, via a network interface device (e.g., a network interface component included in the communication components 236) and using any one of several well-known transfer protocols (e.g., hypertext transfer protocol (HTTP)). Similarly, the instructions 202 can be transmitted or received using a transmission medium via a coupling (e.g., a peer-to-peer coupling) to the devices 240.

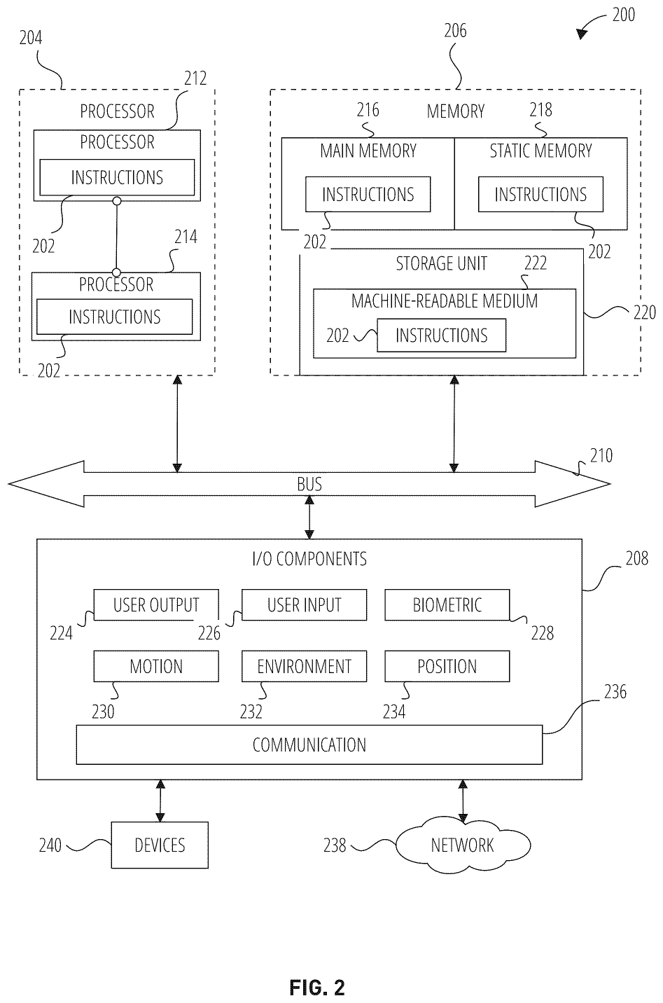

FIG. 3 is a block diagram 300 illustrating a software architecture 302, which can be installed on any one or more of the devices described herein. The software architecture 302 is supported by hardware such as a machine 304 that includes processors 306, memory 308, and I/O components 310. In this example, the software architecture 302 can be conceptualized as a stack of layers, where each layer provides a particular functionality. The software architecture 302 includes layers such as an operating system 312, libraries 314, frameworks 316, and applications 318. Operationally, the applications 318 invoke API calls 320 through the software stack and receive messages 322 in response to the API calls 320.

The operating system 312 manages hardware resources and provides common services. The operating system 312 includes, for example, a kernel 324, services 326, and drivers 328. The kernel 324 acts as an abstraction layer between the hardware and the other software layers. For example, the kernel 324 provides memory management, processor management (e.g., scheduling), component management, networking, and security settings, among other functionalities. The services 326 can provide other common services for the other software layers. The drivers 328 are responsible for controlling or interfacing with the underlying hardware. For instance, the drivers 328 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 314 provide a common low-level infrastructure used by the applications 318. The libraries 314 can include system libraries 330 (e.g., C standard library) that provide functions such as memory allocation functions, string manipulation functions, mathematical functions, and the like. In addition, the libraries 314 can include API libraries 332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 314 can also include a wide variety of other libraries 334 to provide many other APIs to the applications 318.

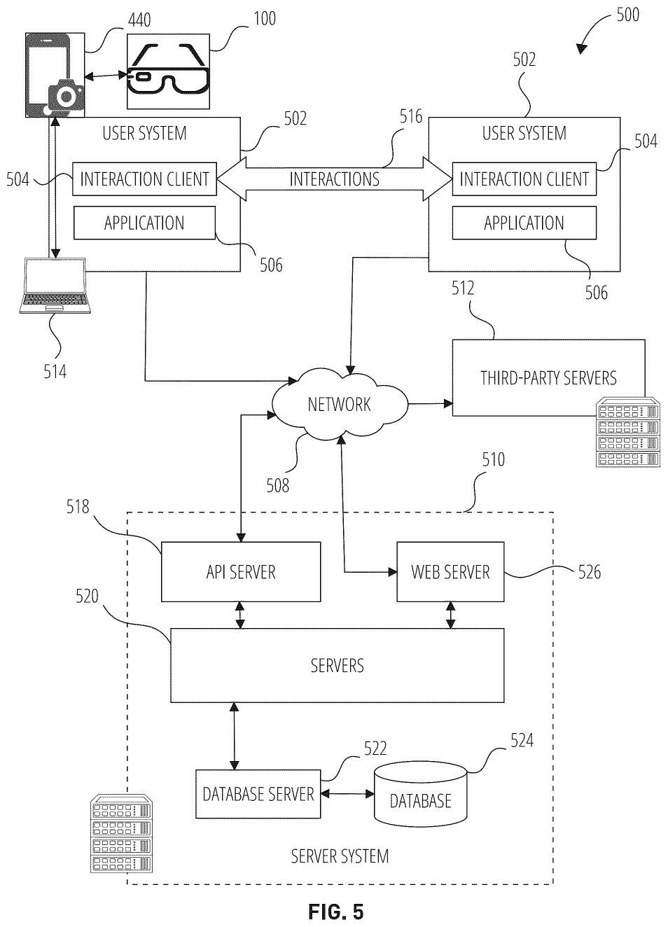

The frameworks 316 provide a common high-level infrastructure that is used by the applications 318. For example, the frameworks 316 provide various graphical user interface (GUI) functions, high-level resource management, and high-level location services. The frameworks 316 can provide a broad spectrum of other APIs that can be used by the applications 318, some of which can be specific to a particular operating system or platform. In some examples, the frameworks 316 include a framework for an XR system as more described in reference to FIG. 6.

In an example, the applications 318 can include a home application 336, a contacts application 338, a browser application 340, a book reader application 342, a location application 344, a media application 346, a messaging application 348, a game application 350, an AI assistant 354, and a broad assortment of other applications such as a third-party application 352.

In some examples, the AI assistant 354 includes a chatbot or the like that provides a conversational style interface for a user of an XR system to interact with various features and functionalities of the XR system. In some examples, the AI assistant can be used to perform tasks such as, but not limited to:
Answer questions and provide information on a wide range of topics.
Generate 2D images, 3D models, and other visual content based on user prompts.
Assist with navigation and provide directions within the XR environment.
Offer recommendations for restaurants, activities, or points of interest.
Help users learn about and interact with their surroundings by providing context and information about objects in view.
Perform web searches and display relevant results in a user interface.
Control system settings and features of an XR device.
Provide step-by-step instructions or tutorials for various tasks.
Assist with scheduling and reminders.
Translate languages in real-time.

The AI assistant can leverage the XR system's capabilities to provide rich, multimodal interactions combining voice, visual, and gesture inputs with audio, visual, and spatial outputs.

The applications 318 are programs that execute functions defined in the programs. Various programming languages can be employed to create one or more of the applications 318, structured in a variety of manners, such as object-oriented programming languages (e.g., Objective-C, Java, or C++) or procedural programming languages (e.g., C or assembly language). In a specific example, the third-party application 352 (e.g., an application developed using the ANDROID™ or IOS™ software development kit (SDK) by an entity other than the vendor of a platform) can be mobile software running on a mobile operating system such as IOS™, ANDROID™, WINDOWS® Phone, or another mobile operating system. In this example, the third-party application 352 can invoke the API calls 320 provided by the operating system 312 to facilitate functionalities described herein.

FIG. 4 illustrates a system 400 including a head-wearable apparatus 100 with a selector input device, according to some examples. FIG. 4 is a high-level functional block diagram of an example head-wearable apparatus 100 communicatively coupled to a mobile device 440 and various server systems 404 via various.

The head-wearable apparatus 100 includes a set of cameras, each of which can be, for example, a visible light camera 406, an infrared emitter 408, and an infrared camera 410.

The mobile device 440 connects with head-wearable apparatus 100 using both a low-power wireless connection 412 and a high-speed wireless connection 414. The mobile device 440 is also connected to the server system 404 and the networks 416.

The head-wearable apparatus 100 further includes a set of image displays of the optical engine 418. The optical engines 418 include one associated with the left lateral side and one associated with the right lateral side of the head-wearable apparatus 100. The head-wearable apparatus 100 also includes an image display driver 420, an image processor 422, low-power circuitry 424, and high-speed circuitry 426. The optical engine 418 is for presenting images and videos, including an image that can include a graphical user interface to a user of the head-wearable apparatus 100.

The image display driver 420 commands and controls the optical engine 418. The image display driver 420 can deliver image data directly to the optical engine 418 for presentation or can convert the image data into a signal or data format suitable for delivery to the image display device. For example, the image data can be video data formatted according to compression formats, such as H.264 (MPEG-4 Part 10), HEVC, Theora, Dirac, RealVideo RV40, VP8, VP9, or the like, and still image data can be formatted according to compression formats such as Portable Network Group (PNG), Joint Photographic Experts Group (JPEG), Tagged Image File Format (TIFF) or exchangeable image file format (EXIF) or the like.

The head-wearable apparatus 100 includes a frame and stems (or temples) extending from a lateral side of the frame. The head-wearable apparatus 100 further includes a user input device 428 (e.g., touch sensor or push button), including an input surface on the head-wearable apparatus 100. The user input device 428 (e.g., touch sensor or push button) is to receive from the user an input selection to manipulate the graphical user interface of the presented image.

The components shown in FIG. 4 for the head-wearable apparatus 100 are located on one or more circuit boards, for example a PCB or flexible PCB, in the rims or temples. Alternatively, or additionally, the depicted components can be located in the chunks, frames, hinges, or bridge of the head-wearable apparatus 100. Left and right visible light cameras 406 can include digital camera elements such as a complementary metal oxide-semiconductor (CMOS) image sensor, charge-coupled device, camera lenses, or any other respective visible or light-capturing elements that can be used to capture data, including images of scenes with unknown objects.

The head-wearable apparatus 100 includes a memory 402, which stores instructions to perform a subset, or all the functions described herein. The memory 402 can also include storage device.

As shown in FIG. 4, the high-speed circuitry 426 includes a high-speed processor 430, a memory 402, and high-speed wireless circuitry 432. In some examples, the image display driver 420 is coupled to the high-speed circuitry 426 and operated by the high-speed processor 430 to drive the left and right image displays of the optical engine 418. The high-speed processor 430 can be any processor capable of managing high-speed communications and operation of any general computing system needed for the head-wearable apparatus 100. The high-speed processor 430 includes processing resources needed for managing high-speed data transfers on a high-speed wireless connection 414 to a wireless local area network (WLAN) using the high-speed wireless circuitry 432. In certain examples, the high-speed processor 430 executes an operating system such as a LINUX operating system or other such operating system of the head-wearable apparatus 100, and the operating system is stored in the memory 402 for execution. In addition to any other responsibilities, the high-speed processor 430 executing a software architecture for the head-wearable apparatus 100 is used to manage data transfers with high-speed wireless circuitry 432. In certain examples, the high-speed wireless circuitry 432 is configured to implement Institute of Electrical and Electronic Engineers (IEEE) 802.11 communication standards, also referred to herein as WI-FI®. In some examples, other high-speed communications standards can be implemented by the high-speed wireless circuitry 432.

The low-power wireless circuitry 434 and the high-speed wireless circuitry 432 of the head-wearable apparatus 100 can include short-range transceivers (e.g., Bluetooth™, Bluetooth LE, Zigbee, ANT+) and wireless wide, local, or wide area Network transceivers (e.g., cellular or WI-FI®). Mobile device 440, including the transceivers communicating via the low-power wireless connection 412 and the high-speed wireless connection 414, can be implemented using details of the architecture of the head-wearable apparatus 100, as can other elements of the network 416.

The memory 402 includes any storage device capable of storing various data and applications, including, among other things, camera data generated by the left and right visible light cameras 406, the infrared camera 410, and the image processor 422, as well as images generated for display by the image display driver 420 on the image displays of the optical engine 418. While the memory 402 is shown as integrated with high-speed circuitry 426, in some examples, the memory 402 can be an independent standalone element of the head-wearable apparatus 100. In certain such examples, electrical routing lines can provide a connection through a chip that includes the high-speed processor 430 from the image processor 422 or the low-power processor 436 to the memory 402. In some examples, the high-speed processor 430 can manage addressing of the memory 402 such that the low-power processor 436 will boot the high-speed processor 430 any time that a read or write operation involving memory 402 is needed.

As shown in FIG. 4, the low-power processor 436 or high-speed processor 430 of the head-wearable apparatus 100 can be coupled to the camera (visible light camera 406, infrared emitter 408, or infrared camera 410), the image display driver 420, the user input device 428 (e.g., touch sensor or push button), and the memory 402.

The head-wearable apparatus 100 is connected to a host computer. For example, the head-wearable apparatus 100 is paired with the mobile device 440 via the high-speed wireless connection 414 or connected to the server system 404 via the network 416. The server system 404 can be one or more computing devices as part of a service or network computing system, for example, that includes a processor, a memory, and network communication interface to communicate over the network 416 with the mobile device 440 and the head-wearable apparatus 100.

The mobile device 440 includes a processor and a Network communication interface coupled to the processor. The Network communication interface allows for communication over the network 416, low-power wireless connection 412, or high-speed wireless connection 414. The mobile device 440 can further store at least portions of the instructions in the memory of the mobile device 440 memory to implement the functionality described herein.

Output components of the mobile device 440 include visual components, such as a display such as a liquid crystal display (LCD), a plasma display panel (PDP), a light-emitting diode (LED) display, a projector, or a waveguide. The image displays of the optical assembly are driven by the image display driver 420. The output components of the mobile device 440 further include acoustic components (e.g., speakers), haptic components (e.g., a vibratory motor), other signal generators, and so forth. The input components of the mobile device 440, the mobile device 440, and server system 404, such as the user input device 428, can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 100 can also include additional peripheral device elements. Such peripheral device elements can include sensors and display elements integrated with the head-wearable apparatus 100. For example, peripheral device elements can include any I/O components including output components, motion components, position components, or any other such elements described herein.

In some examples, the head-wearable apparatus 100 can include biometric components or sensors to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components can include a brain-machine interface (BMI) system that allows communication between the brain and an external device or machine. This can be achieved by recording brain activity data, translating this data into a format that can be understood by a computer, and then using the resulting signals to control the device or machine.

### Example Types of BMI Technologies, Including:

Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data can be used for very limited purposes, such as identification verification. To ensure limited and authorized use of biometric information and other personally identifiable information (PII), access to this data is restricted to authorized personnel only, if at all. Any use of biometric data can strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude can be derived), orientation sensor components (e.g., magnetometers), and the like. Such positioning system coordinates can also be received over low-power wireless connections 412 and high-speed wireless connection 414 from the mobile device 440 via the low-power wireless circuitry 434 or high-speed wireless circuitry 432.

FIG. 5 is a block diagram showing an example digital interaction system 500 for facilitating interactions and engagements (e.g., exchanging text messages, conducting text audio and video calls, or playing games) over a network. The digital interaction system 500 includes multiple user systems 502, each of which hosts multiple applications, including an interaction client 504 and other applications 506. Each interaction client 504 is communicatively coupled, via one or more networks including a network 508 (e.g., the Internet), to other instances of the interaction client 504 (e.g., hosted on respective other user systems), a server system 510 and third-party servers 512). An interaction client 504 can also communicate with locally hosted applications 506 using Applications Program Interfaces (APIs).

Each user system 502 can include multiple user devices, such as a mobile device 440, head-wearable apparatus 100, and a computer client device 514 that are communicatively connected to exchange data and messages.

An interaction client 504 interacts with other interaction clients 504 and with the server system 510 via the network 508. The data exchanged between the interaction clients 504 (e.g., interactions 516) and between the interaction clients 504 and the server system 510 includes functions (e.g., commands to invoke functions) and payload data (e.g., text, audio, video, or other multimedia data).

The server system 510 provides server-side functionality via the network 508 to the interaction clients 504. While certain functions of the digital interaction system 500 are described herein as being performed by either an interaction client 504 or by the server system 510, the location of certain functionality either within the interaction client 504 or the server system 510 can be a design choice. For example, it can be technically preferable to initially deploy particular technology and functionality within the server system 510 but to later migrate this technology and functionality to the interaction client 504 where a user system 502 has sufficient processing capacity.

The server system 510 supports various services and operations that are provided to the interaction clients 504. Such operations include transmitting data to, receiving data from, and processing data generated by the interaction clients 504. This data can include message content, client device information, geolocation information, digital effects (e.g., filters, media augmentation, overlays, XR effects, and the like), message content persistence conditions, entity relationship information, and live event information. Data exchanges within the digital interaction system 500 are invoked and controlled through functions available via user interfaces (UIs) of the interaction clients 504.

In some examples, the server system 510 provides services for processing image and textual data using generative models. The generative models can be used to perform tasks such as, but not limited to:
Generate 2D images based on textual descriptions or prompts provided by users.
Create 3D models or objects that can be displayed in the XR environment.
Produce synthetic voice responses that match the AI assistant's personality.
Generate text responses in a conversational style for an AI assistant interface.
Transform or edit existing images based on user instructions.
Create animations for a 3D bitmoji avatar representing an AI assistant's state.
Generate contextual prompts or suggestions based on the user's environment or recent interactions.
Synthesize new content by combining elements from multiple sources or modalities.
Produce personalized content tailored to the user's preferences or history.
Generate code snippets or scripts for creating custom XR experiences or interactions.

Turning now specifically to the server system 510, an Application Program Interface (API) server 518 is coupled to and provides programmatic interfaces to servers 520, making the functions of the servers 520 accessible to interaction clients 504, other applications 506 and third-party server 512. The servers 520 are communicatively coupled to a database server 522, facilitating access to a database 524 that stores data associated with interactions processed by the servers 520. Similarly, a web server 526 is coupled to the servers 520 and provides web-based interfaces to the servers 520. To this end, the web server 526 processes incoming network requests over the Hypertext Transfer Protocol (HTTP) and several other related protocols.

The Application Program Interface (API) server 518 receives and transmits interaction data (e.g., commands and message payloads) between the servers 520 and the user systems 502 (and, for example, interaction clients 504 and other application 506) and the third-party server 512. Specifically, the Application Program Interface (API) server 518 provides a set of interfaces (e.g., routines and protocols) that can be called or queried by the interaction client 504 and other applications 506 to invoke functionality of the servers 520. The Application Program Interface (API) server 518 exposes various functions supported by the servers 520, including account registration; login functionality; the sending of interaction data, via the servers 520, from a particular interaction client 504 to another interaction client 504; the communication of media files (e.g., images or video) from an interaction client 504 to the servers 520; the settings of a collection of media data (e.g., a narrative); the retrieval of a list of friends of a user of a user system 502; the retrieval of messages and content; the addition and deletion of entities (e.g., friends) to an entity relationship graph; the location of friends within an entity relationship graph; and opening an application event (e.g., relating to the interaction client 504).

The interaction client 504 provides a user interface that allows users to access features and functions of an external resource, such as a linked application 506, an applet, or a microservice. This external resource can be provided by a third party or by the creator of the interaction client 504.

The external resource can be a full-scale application installed on the user's system 502, or a smaller, lightweight version of the application, such as an applet or a microservice, hosted either on the user's system or remotely, such as on third-party servers 512 or in the cloud. These smaller versions, which include a subset of the full application's features, can be implemented using a markup-language document and can also incorporate a scripting language and a style sheet.

When a user selects an option to launch or access the external resource, the interaction client 504 determines whether the resource is web-based or a locally installed application. Locally installed applications can be launched independently of the interaction client 504, while applets and microservices can be launched or accessed via the interaction client 504.

If the external resource is a locally installed application, the interaction client 504 instructs the user's system to launch the resource by executing locally stored code. If the resource is web-based, the interaction client 504 communicates with third-party servers to obtain a markup-language document corresponding to the selected resource, which it then processes to present the resource within its user interface.

The interaction client 504 can also notify users of activity in one or more external resources. For instance, it can provide notifications relating to the use of an external resource by one or more members of a user group. Users can be invited to join an active external resource or to launch a recently used but currently inactive resource.

The interaction client 504 can present a list of available external resources to a user, allowing them to launch or access a given resource. This list can be presented in a context-sensitive menu, with icons representing different applications, applets, or microservices varying based on how the menu is launched by the user.

FIG. 6 illustrates a collaboration diagram of components of an XR system 610, such as head-wearable apparatus 100 of FIG. 1A, using hand-tracking for user input, according to some examples.

The XR system 610 uses 3D tracking data 638 and hand touch data 664 to provide continuous real-time input modalities to a user 608 of the XR system 610 where the user 608 interacts with one or more user interfaces 618 using hand-tracking and hand touch input modalities. Using the hand-tracking and hand touch input modalities, the XR system 610 generates user interface input/output (UI I/O) data 670 that are used by one or more applications 690.

The applications executed by the XR system 610 generate application user interfaces that provide features such as, but not limited to, a chatbot, an AI assistant, maintenance guides, interactive maps, interactive tour guides, tutorials, and the like. The applications can also be entertainment applications such as, but not limited to, video games, interactive videos, and the like.

The XR system 610 generates a user interface 618 provided to the user 608 within an XR environment. The user interface 618 includes one or more virtual objects in a form of a set of user interface elements 634 that the user 608 can interact with. For example, an XR user interface engine 606 of FIG. 6 includes user interface control logic 628 including a dialog script or the like that specifies a user interface dialog implemented by the user interface 618. The user interface control logic 628 also includes one or more actions that are to be taken by the XR system 610 based on detecting various dialog events such as user inputs input by the user 608 using the user interface 618 and by making hand gestures. The XR user interface engine 606 further includes a user interface object model 626. The user interface object model 626 includes 3D coordinate data of the one or more user interfaces 618 and the set of user interface elements 634. The 3D graphics data is used by an optical engine 617 to generate the user interface 618 provided to the user 608.

The XR user interface engine 606 generates user interface data 612 using the user interface object model 626. The user interface data 612 includes image data of the set of user interface elements 634 of the user interface 618. The XR user interface engine 606 communicates the user interface data 612 to a display driver 614 of an optical engine 617 of the XR system 610. The display driver 614 receives the user interface data 612 and generates display control signals using the user interface data 612. The display driver 614 uses the display control signals to control the operations of a set of optical assemblies 602 of the optical engine 617. In response to the display control signals, the set of optical assemblies 602 generate a user interface graphics display 632 of the user interface 618 provided to the user 608.

While in use, the XR system 610 uses set of tracking sensors 620 to detect and record a position, orientation, and gestures of the hands 624 of the user 608. This can involve capturing the speed and trajectory of hand movements, recognizing specific hand poses, and determining the relative positioning of the hands in the three-dimensional space of an XR environment.

In some examples, the set of tracking sensors 620 include an array of optical sensors capable of capturing a wide range of hand movements and gestures in real-time as images. These sensors can include Red Green and Blue (RGB) cameras that capture images of the hands 624 of the user 608 using light having a broad wavelength spectrum, such as natural light provided by the real-world environment or artificial illumination created by a set of incandescent lamps, LED lamps, or the like provided by the XR system 610. In some examples, the set of tracking sensors 620 can include infrared cameras that capture images of the hands 624 of the user 608 using energy in the infrared radiation (IR) spectrum. The IR energy can be supplied by a set of IR emitters of the XR system 610.

In some examples, the set of tracking sensors 620 include depth-sensing cameras that utilize structured light or time-of-flight technology to create a three-dimensional model of the hands 624 of the user 608. This allows the XR system 610 to detect intricate gestures and finger movements with high accuracy.

In some examples, the set of tracking sensors 620 include ultrasonic sensors that emit sound waves and measure the reflection off the hands 624 of the user 608 to determine their location and movement in space.

In some examples, the set of tracking sensors 620 include electromagnetic field sensors that track the movement of the hands 624 of the user 608 by detecting changes in an electromagnetic field generated around the user 608.

In some examples, the set of tracking sensors 620 include capacitive sensors embedded in gloves worn by the user 608. These sensors detect hand movements and gestures based on changes in capacitance caused by finger positioning and orientation.

In some examples, the XR system 610 includes set of pose sensors 648 such as an Inertial Measurement Unit (IMU) and the like, that track the orientation and movements of the XR system of the user 608. The set of pose sensors 648 are used to determine Six Degrees of Freedom (6DoF) data of movement of the XR system 610 in three-dimensional space. Specifically, the 6DoF data encompasses three translational movements along the x, y, and z axes (forward/back, up/down, left/right) and three rotational movements (pitch, yaw, roll) included in pose data 650. In the context of XR, 6DoF data is allows for the tracking of both position and orientation of an object or user in 3D space.

In some examples, the set of pose sensors 648 includes a set of cameras that capture images of the real-world environment. The images are included in the pose data 650. The XR system 610 uses the images and photogrammetric methodologies to determine 6DoF data of the XR system 610.

In some examples, the XR system 610 uses a combination of an IMU and a set of cameras to determine 6DoF for the XR system 610.

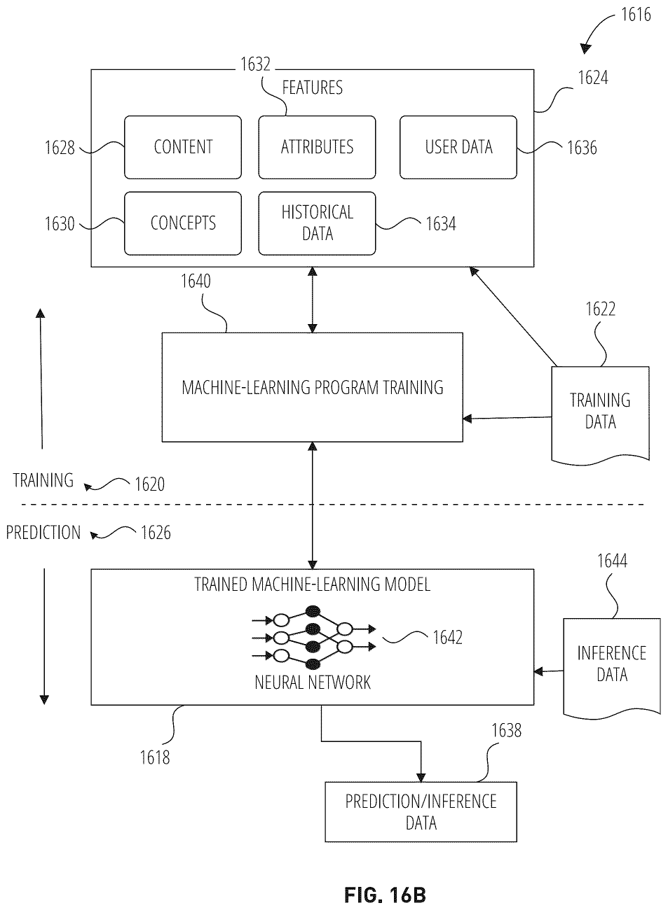

In some examples, the XR system 610 uses a set of audio sensors 682 to capture user speech of the user 608. The set of audio sensors 682 capture the user speech and generate audio data 688 that is communicated to a speech recognition pipeline 680. The speech recognition pipeline 680 receives the audio data 688 and generates speech data 686 that is communicated to the XR user interface engine 606 for processing as user input. In some examples, the speech recognition pipeline 680 includes a set of speech recognition models 684 used to process the audio data 688 into speech data 686. The training of a speech recognition model 684 is more fully described in reference to FIG. 16A and FIG. 16B.

In some examples, the XR system 610 uses a tracking pipeline 616 including a Region Of Interest (ROI) detector 630, a tracker 604, and a 3D model generator 640, to generate the 3D tracking data 638 using the tracking data 622 and the pose data 650.

The ROI detector 630 uses a ROI detector model 609 to detect a region in the real world environment that includes a hand 624 of the user 608. The ROI detector model 609 is trained to recognize those portions of the real-world environment that include a user's hands as more fully described in reference to FIG. 16A and FIG. 16B. The ROI detector 630 generates ROI data 636 indicating which portions of the tracking data 622 include one or both hands of the user 608 and communicates the ROI data 636 to the tracker 604.

The tracker 604 uses a tracking model 644 to generate 2D tracking data 642. The tracker 604 uses the tracking model 644 to recognize landmark features on portions of the one or both hands 624 of the user 608 captured in the tracking data 622 and within the ROI identified by the ROI detector 630. The tracker 604 extracts landmarks of the one or both hands 624 of the user 608 from the tracking data 622 using computer vision methodologies including, but not limited to, Harris corner detection, Shi-Tomasi corner detection, Scale-Invariant Feature Transform (SIFT), Speeded-Up Robust Features (SURF), Features from Accelerated Segment Test (FAST), Oriented FAST and Rotated BRIEF (ORB), and the like. The tracking model 644 operates on the landmarks to generate the 2D tracking data 642 that includes a sequence of skeletal models of one or both hands of the user 608. The tracking model 644 is trained to generate the 2D tracking data 642 as more fully described in reference to FIG. 16A and FIG. 16B. The tracker communicates the 2D tracking data 642 to the 3D model generator 640.

The 3D model generator 640 receives the 2D tracking data 642 and generates 3D tracking data 638 using the 2D tracking data 642, the pose data 650, and a 3D coordinate generator model 646. For example, the 3D model generator 640 determines a reference position in the real-world environment for the XR system 610. The 3D model generator 640 uses a 3D coordinate generator model 646 that operates on the 2D tracking data 642 to generate the 3D tracking data 638. The 3D coordinate generator model 646 is trained to generate the 3D tracking data 638 as more fully described in reference to FIG. 16A and FIG. 16B.

In some examples, the tracker 604 generates the 3D tracking data 638 using photogrammetry methodologies to create 3D models of the hands of the user 608 from the 2D tracking data 642 by capturing overlapping pictures of the hands of the user 608 from different angles. In some examples, the 2D tracking data 642 includes multiple images taken from different angles, which are then processed to generate the 3D models that are included in the 3D tracking data 638. In some examples, the XR system 610 uses the pose data 650 captured by a set of pose sensors 648 to determine an angle or position of the XR system 610 as an image is captured of the hands of the user 608.

The XR system 610 uses a hand touch detection pipeline 654 including an image processor 656 and a hand touch detector 658 to generate hand touch data 664 using the tracking data 622.

In some examples, the image processor 656 extracts features from the tracking data 622 using computer vision methodologies including, but not limited to, Harris corner detection, Shi-Tomasi corner detection, Scale-Invariant Feature Transform (SIFT), Speeded-Up Robust Features (SURF), Features from Accelerated Segment Test (FAST), Oriented FAST and Rotated BRIEF (ORB), and the like. The image processor 656 operates on the features to generate the cropped image data 666. The image processor 656 is trained to generate the cropped image data 666 as more fully described in reference to FIG. 16A and FIG. 16B.

In some examples, images in the tracking data 622 are processed by an image processor 656 to enhance the images for better clarity and contrast, making it easier for the XR system 610 to extract features from the tracking data 622. In some examples, the image processor 656 uses image enhancement methodologies such as, but not limited to: histogram equalization, which adjusts the contrast of an image by redistributing the intensity values; Gaussian smoothing, which reduces noise and detail by averaging pixel values with a Gaussian kernel; unsharp mask filtering, which enhances edges by subtracting a blurred version of the image from the original; Wiener filtering, which removes noise and deblurs images by accounting for both the degradation function and the statistical properties of noise; Contrast-Limited Adaptive Histogram Equalization (CLAHE), which improves local contrast and enhances the definition of edges in an image; median filtering, which reduces noise by replacing each pixel's value with the median value of the intensities in its neighborhood; point operations, which apply the same transformation to each pixel based on its original value, such as intensity transformations; spatial filtering, which involves convolution of the image with a kernel to achieve effects like blurring or sharpening; and the like.

In some examples, the image processor 656 filters the images to remove background noise and enhance the visibility of a portion of a hand 624 and a digit used by the user 608 to make the hand touch. This processing helps the XR system 610 to accurately detect and interpret the specific interactions intended by the user 608. This capability is useful in complex visual environments where background noise could otherwise interfere with the ability of the XR system 610 to correctly detect a hand touch.

The image processor 656 detects portions of images of the tracking data 622 that include image data of the hands 624 of the user 608 and crops the images to generate cropped image data 666 including the image data of the hands 624. The image processor 656 generates the cropped image data 666 and communicates the cropped image data 666 to the hand touch detector 658.

In some examples, the image processor 656 uses a cropping model 662 to crop the images of the tracking data 622 that include image data of the hands 624. Training of the cropping model 662 more fully described in reference to FIG. 16A and FIG. 16B.

In some examples, the image processor 656 uses a hand tracking process to isolate a palmar surface or a hand dorsal surface in images of the hands 624 of the user 608. This process is useful for focusing the analysis on the most relevant part of a palmar surface or a hand dorsal surface for interaction, which enhances the ability of the XR system 610 to accurately detect and interpret user inputs. By isolating the palmar surface or hand dorsal surface, the XR system 610 can more effectively process and respond to gestures and touches, improving the overall user experience in XR applications. This targeted processing helps in reducing noise and distractions from other parts of the hand or background, improving the precision and reliability of the hand touch detection.

In some examples, the image processor 656 uses the hand tracking process to crop an image to isolate an area around a tip of a digit being used by the user 608 to make a hand touch.

In some examples, the image processor 656 adjusts the cropping of the cropped images to enhance features indicative of the hand touch. This adjustment is useful for improving the accuracy of hand touch detection by focusing on specific areas of the image where hand touch interactions are most likely to occur. By enhancing these features, the XR system 610 can more effectively interpret user inputs, leading to a more responsive and intuitive user experience within the XR environment. This capability is particularly useful for applications requiring precise control and interaction, such as virtual reality gaming or complex navigational tasks in augmented reality settings.

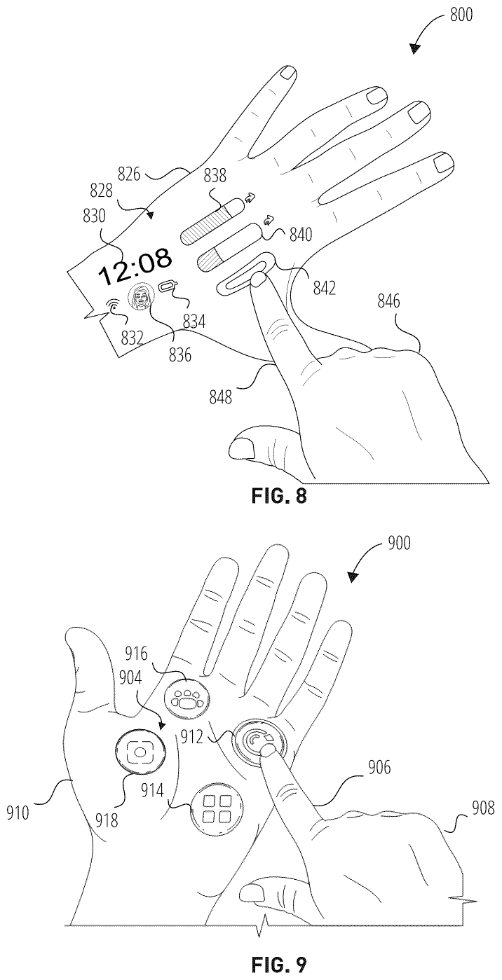

The hand touch detector 658 uses a hand touch model 660 to generate the hand touch data 664. The hand touch detector 658 uses the hand touch model 660 to recognize when the user 608 touches a portion of a first one of their hands 624 using one or more digits of a second one of their hands 624. FIG. 9 illustrates a hand touch event of a palmar surface 904 of the (first) hand 910 of a user by a digit 906 of the other (second) of the user. The digit 906 pressing against the palmar surface 904 generates a deformation in the palmar surface 904. The XR system captures image data of the deformation and uses the hand touch detection pipeline 654 that uses the image data of the deformation to detect that the user is touching the palmar surface 904 and generates a hand touch event included in the hand touch data 664.

In some examples, the portion of the hand being touched is the palmar surface of the non-dominant hand of the user and the one or more digits are one or more digits of the dominant hand of the user.

In some examples, the portion of the hand being touched is the hand dorsal surface of the non-dominant hand of the user and the one or more digits are one or more digits of the dominant hand of the user.

In some examples, the portion of the hand being touched is the palmar surface of the dominant hand of the user and the one or more digits are one or more digits of the non-dominant hand of the user.

In some examples, the portion of the hand being touched is the hand dorsal surface of the dominant hand of the user and the one or more digits are one or more digits of the non-dominant hand of the user.

When a hand touch is detected by the hand touch detection pipeline 654, the hand touch detection pipeline 654 communicates hand touch data 664 including data of the hand touch to the XR user interface engine 606.

The hand touch model 660 is trained to generate the hand touch data 664 as more fully described in reference to FIG. 16A, and FIG. 16B.

In some examples, the hand touch model 660 is retrained using a training data collected by the XR system as the XR system prompts the user 608 to perform specific operations such as, but not limited to, holding a digit over a palm of one their hands, palm touching specific portions of their palm, and the like. This retraining process is useful for personalizing the model to the specific characteristics and preferences of the user 608. By incorporating user-specific data, the XR system 610 can enhance hand touch accuracy and responsiveness to a user's unique way of interacting with the XR system 610. This capability is particularly beneficial in applications where user comfort and customization improve the overall experience, such as in personalized virtual assistance or adaptive gaming environments.

In some examples, the hand touch detection sensitivity of the hand touch detection pipeline 654 is calibrated using a set of individual hand characteristics of the user 608. This calibration process is useful for tailoring the system's sensitivity to the unique physical attributes of the user's hands, such as size, shape, and touch pressure tendencies.

In some examples, detecting a hand touch of a palm by a digit of a hand includes interpolating between different hand touch pressure levels detected in the cropped images. For example, the hand touch detector 658 uses the hand touch model 660 to detect variations in visual cues such as, but not limited to, shadowing, indentation, skin deformation, and the like, which are captured in the cropped images. By interpolating these subtle differences, the XR system 610 can determine not just the presence of a touch, but also the varying degrees of pressure applied. In some examples, the hand touch detector 658 generates data of a hand touch that includes a continuous parameter that has a value representing states of a hand touch from a hover state to a hard press state. As an example, the continuous value can be a real number having a range from 0.0 to 2.0 where 0.0 represents a hover of a digit over a palm, 1.0 represents a light pressure hand touch, and 2.0 represents a heavy pressure hand touch, and a value between 0.0 and 1.0 represents a distance between the digit and the palm without a hand touch corresponding to the user 608 holding their digit 906 just above their palmar surface 904 in a hover position.

In some examples, the XR system 610 uses geometric methodologies to detect when the user 608 interacts with the user interface elements 634 of a user interface 618. The XR system 610 does so by using hand models of one or both hands 624 of the user 608 and virtual colliders associated with the hand models and the user interface elements 634. For example, the XR system 610 uses the 3D tracking data 638 to generate hand models of one or both of the hands 624 of the user. The XR user interface engine 606 generates a set of virtual colliders using the hand models and stores data of the colliders in the user interface object model 626. The XR user interface engine 606 generates a set of user interface elements 634 for a user interface where the set of user interface elements 634 include geometric data of one or more virtual colliders associated with the set of user interface elements 634. The XR user interface engine 606 includes the virtual colliders associated with the set of user interface element 634 in the user interface object model 626. In use, the XR user interface engine 606 determines that the user 608 is interacting with one or more of the user interface elements by detecting a collision or intersection between the virtual colliders of the hand models with the virtual colliders of the set of user interface elements 634.

In some examples, the XR system 610 uses artificial intelligence methodologies to detect when the user 608 makes hand gestures when interacting with the user interface elements 634 of a user interface 618. The XR system 610 does so by using a hand gesture recognition model (not shown) that receives the 3D tracking data 638 and recognizes motions made by the user using one or both of their hands 624 as hand gestures. The hand gestures are included in the 3D tracking data 638 communicated to the XR user interface engine 606 for processing as inputs into an application being executed by the XR system. The structure and training of the hand gesture recognition model is more fully described in reference to FIG. 16A and FIG. 16B.

In some examples, the set of tracking sensors 620 include visible light cameras such as, but not limited to, RGB cameras, that capture the images of the hands 624 of user 608. The cropped images are processed by the image processor 656 to emphasize depth cues visible in the hands 624 of the user in the RGB spectrum. This processing is useful for enhancing the visual information used for accurately interpreting hand movements and interactions within the XR environment. By emphasizing depth cues, the XR system 610 can more effectively discern the spatial relationships and gestures of the user's hands, leading to more precise and responsive interactions in virtual and augmented reality applications.

In some examples, the XR system 610 is operably connected to a mobile device 652. The user 608 can use the mobile device 652 to configure the XR system 610. In some examples, the mobile device 652 functions as an alternative input modality.

In some examples, an XR system performs the functions of the tracking pipeline 616, the hand touch detection pipeline 654, the XR user interface engine 606, and the optical engine 617 utilizing various APIs and system libraries.

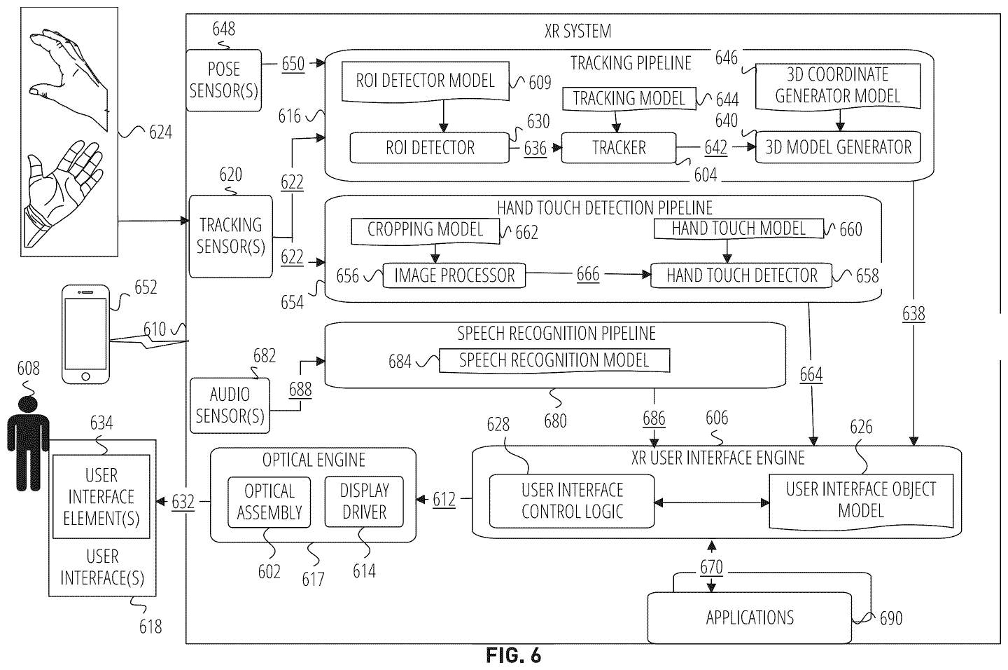

FIG. 7 illustrates an example hand-centric user interface method 700, according to some examples. An XR system, such as XR system 610 of FIG. 6, uses the hand-centric user interface method 700 to generate an adaptive hand-centric user interface to a user of the XR system.

Although the example hand-centric user interface method 700 depicts a particular sequence of operations, the sequence may be altered without departing from the scope of the present disclosure. For example, some of the operations depicted may be performed in parallel or in a different sequence that does not materially affect the function of the hand-centric user interface method 700. In other examples, different components of an XR system that implements the hand-centric user interface method 700 may perform functions at substantially the same time or in a specific sequence.

In operation 702, the XR system detects, using a set of tracking sensors of the XR system, a position and an orientation of a hand of a user. For example, the XR system can use a set of tracking sensors and a tracking pipeline to generate 3D tracking data used to detect and record the position and orientation of one or both hands of the user as more fully described in reference to FIG. 6.

In operation 704, the XR system determines a surface of the hand facing the user using the position and the orientation of the hand. For example, the XR system can use the position and orientation data of the user's hand detected by the set of tracking sensors to determine if a dorsal surface or a palmar surface of the hand is facing the user. In some examples, this determination involves analyzing the 3D tracking data generated by a 3D model generator to calculate the angle and position of the hand relative to the user's field of view. The XR system can use this information to infer whether the palmar surface or the dorsal surface of the hand is facing the user. In some examples, the XR system can use data from a set of pose sensors, such as an IMU of the like, to determine the orientation of the user's head and combine this with the hand tracking data to determine the position and orientation of the user's hand. This process allows the XR system to dynamically adapt the hand-centric user interface based on how the user is positioning their hand to face either the palmar surface or the dorsal surface to the user. In some examples, the XR system can determine if a user is holding their hand in a position that a dorsal surface of the user's hand is exposed to the user, such as by the dorsal surface facing upward in a frame of reference of the user. In some examples, the XR system can determine if the user is holding their hand in a position that a palmar surface of their hand is exposed to the user, such as by the palmar surface facing upward in the frame of reference of the user.

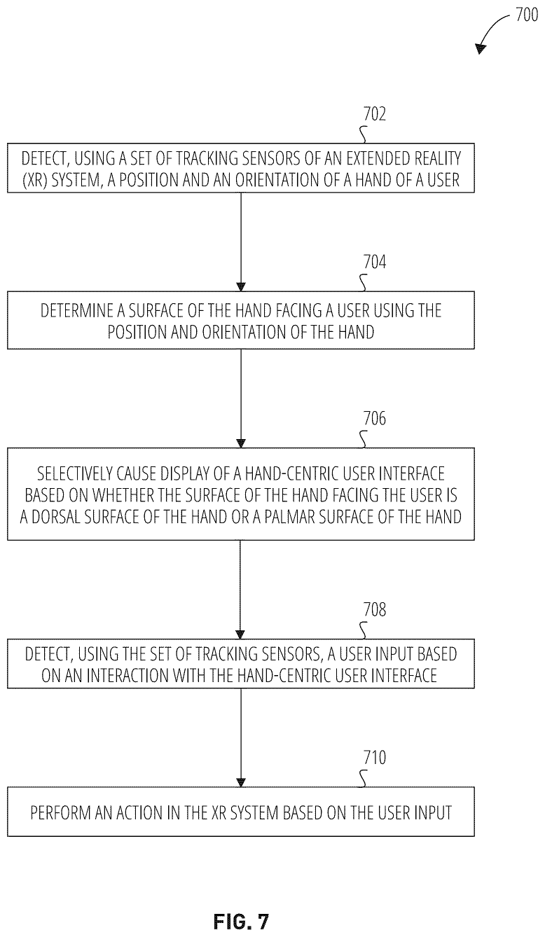

In operation 706, the XR system selectively causes display of a hand-centric user interface based on whether the surface of the hand facing the user is a dorsal surface of the hand or a palmar surface of the hand. For example, in reference to FIG. 8, in response to determining the dorsal surface of the hand is facing the user, the XR system causes display of a dorsal hand-centric user interface 800 using a set of dorsal user interface elements. The XR system can use an XR user interface engine to generate and display the dorsal hand-centric user interface 800 on the dorsal surface of the user's hand 826 when the user view is determined to be of the dorsal surface 828. The XR user interface engine can utilize a user interface object model, which includes 3D coordinate data of a set of dorsal user interface elements. The user interface data is sent to a display driver of an optical engine, which controls a set of optical assemblies to produce a user interface graphics display as more fully described in reference to FIG. 6. The user interface graphics display is displayed on the dorsal surface 828 of the user's hand 826 as the dorsal hand-centric user interface 800.

In some examples, the dorsal hand-centric user interface 800 includes a status watch 830 displayed on a dorsal surface of the wrist of the hand 826. The status watch 830 shows the time “12:08” and includes additional system status indicators such as a network status icon 832 and a battery level icon 834, providing system status information to the user. A wrist user interface element 836 is displayed on the dorsal surface of the wrist and includes a user specific icon representing a user profile or avatar.

On the dorsal surface 828 of the hand 826, a set of dorsal user interface elements are displayed: dorsal user interface element 838, dorsal user interface element 840, and dorsal user interface element 842. Dorsal user interface element 838 and dorsal user interface element 840 are used to input various system level settings such as, but not limited to a volume level of an audio device of the XR system, a brightness level of an optical display element of the XR system, and the like. In some examples, dorsal user interface element 842 is selectable by the user to programmatically change what system settings are represented by, and adjustable using, dorsal user interface element 838 and dorsal user interface element 840.

In some examples, the set of dorsal user interface elements are virtual sliders that the user can slide back and forth to input a system setting value. In some examples, the dorsal user interface elements can be of different types of virtual control elements of the dorsal hand-centric user interface 800 such as, but not limited to, buttons, knobs, switches, and the like. In some examples, a longitudinal axis of a dorsal user interface element is aligned along a longitudinal axis of the hand 826.

To interact with the dorsal hand-centric user interface 800, the user uses a digit 848 of their other (second) hand 846 and touches their (first) hand 826 at a location corresponding to a location of the user interface element. In some examples, the XR system can detect the user's interaction with the set of dorsal user interface elements using a hand touch detection pipeline or geometric methodologies as more fully described in reference to FIG. 6.

In some examples, a set of dorsal user interface elements may include sliders, icons, buttons, or other interactive elements specifically designed for the dorsal surface 828 of the hand 826.

In some examples, the XR system can dynamically render a set of user interface elements as textures and apply them to a 3D mesh of the user's hand. For example, the XR system generates a hand-centric user interface by first creating a three-dimensional (3D) mesh of the user's hand based on a detected position and orientation. This 3D mesh serves as a digital representation of the hand's geometry. The XR system then dynamically renders a set of user interface elements as a texture. This texture contains the visual representation of the user interface components, such as switches, sliders, buttons, icons, or other interactive elements of a user interface. The XR system applies the rendered texture to the 3D mesh of the hand using UV mapping techniques. UV mapping allows the 2D texture to be wrapped around the 3D mesh, effectively displaying the hand-centric user interface on the surface of the user's hand 826 in the XR environment. This process enables the user interface to adapt to the hand's movements and deformations, creating a “tattoo-like” effect where the interface appears to be part of the user's skin, contracting and expanding with hand movements.

In some examples, the XR system can dynamically adjust the size, position, or density of user interface elements to optimize visual comfort and interaction accuracy. This adjustment can be based on factors such as the focal plane of a XR display device or the user's hand size. By adapting these parameters, the XR system can ensure that a hand-centric user interface remains visually comfortable and easy to interact with, regardless of individual user characteristics or viewing conditions. This adaptive approach allows the hand-centric user interface to accommodate different hand sizes and shapes, as well as account for the specific optical properties of the XR display device, enhancing the overall usability and comfort of the hand-centric user interface.

In some examples, the XR system continuously monitors a position and orientation of a user's hand using a set of tracking sensors. When a change in the hand's position or orientation is detected, the XR system dynamically updates the rendered texture on the 3D mesh of the hand. This process involves re-rendering the user interface elements as a texture and re-applying it to the updated 3D mesh, which reflects the new position and orientation of the hand. The dynamic updating ensures that the hand-centric user interface maintains its appearance and functionality relative to the hand's surface, regardless of how the user moves or rotates their hand. This adaptive behavior allows the interface to remain usable and intuitive, following the natural movements of the user's hand in the XR environment.

In some examples, a hand-centric user interface leverages the user's proprioception and provides a natural, always-available surface for interaction within an XR environment. For example, an XR system can use a set of cameras with a wider field of view than optical elements providing an XR environment to provide a proprioceptive hand-centric user interface to a user. The set of tracking sensors can capture a larger area around the user, including their hands and arms, even when they are outside the user's direct field of view. By using tracking sensors with a wider field of view, the system can continuously track the position and orientation of the user's hands, even when they are at the periphery of or outside a current XR display of an XR environment. This allows the XR system to detect and interpret hand gestures and movements that might otherwise be missed if relying solely on sensors with the same field of view as the XR display. By leveraging the user's proprioception and the natural movements of their hands, this approach provides an always-available, intuitive interface for interacting with the XR environment, even when the user's hands are not directly in their line of sight.

The use of a dorsal surface of a user's hand for display of a set of user interface elements allows for a potentially rich and diverse set of interactions without the need for physical hardware or traditional input devices.

Referring to FIG. 7, in operation 706, in response to determining the palmar surface of the hand is facing the user, the XR system selectively causes display of a hand-centric user interface on the palmar surface using a set of palmar user interface elements. For example, in reference to FIG. 9, the XR system can use an XR user interface engine to generate and display a palmar hand-centric user interface 900 on the palmar surface 904 of the user's hand 910 when the palmar surface 904 is facing the user. The XR user interface engine can utilize a user interface object model, which includes 3D coordinate data of a set of palmar user interface elements, such as palmar user interface element 916, palmar user interface element 912, palmar user interface element 914, and palmar user interface element 918 to generate user interface data. The user interface data is sent to a display driver of an optical engine, which controls a set of optical assemblies to produce a user interface graphics display as more fully described in reference to FIG. 6. The user interface graphics display is displayed on the palmar surface 904 of the user's hand 910 as the palmar hand-centric user interface 900.

In some examples, the system may adjust the size, position, or density of the palmar user interface elements based on factors such as the focal plane of an XR display device or the user's hand size, to optimize visual comfort and interaction accuracy as more fully described in reference to FIG. 8.

In some examples, the XR system can dynamically render a set of palmar user interface elements as textures and apply them to a 3D mesh of the user's hand as more fully described in reference to FIG. 8.

In some examples, the XR system can provide proprioceptive palmar hand-centric user interface to a user as more fully described in reference to FIG. 8.

In some examples, the set of palmar user interface elements is provided to the user in association with a specified location of the palmar surface 904 of the hand 910 of the user. For example, a palmar user interface element can be provided in association with specific fleshy portions of the palmar surface 904 such as, but not limited to, the thenar eminence at the thumb base, the hypothenar eminence at the little finger side of the palmar surface 904, one or more interdigital spaces between fingers, and the like.

In some examples, the design of the palmar hand-centric user interface 900 intentionally avoids placing user interface elements in sensitive or ticklish areas of the hand, such as the center of the palm or near the wrist, to prevent discomfort or involuntary reactions during use. Instead, user interface elements are positioned in areas that are less sensitive yet remain easily accessible for pressing.

Palmar user interface element 918, palmar user interface element 916, palmar user interface element 912, and palmar user interface element 914 are provided to the user overlaid on the palmar surface 904 of the hand 910 of the user. The user interacts with a palmar user interface element by touching the palmar surface 904 with a digit 906 of their other (second) hand 908 to a portion of the palmar surface 904 that corresponds to an apparent location on the palmar surface 904 of the palmar user interface element, such as palmar user interface element 912. As the palmar surface 904 is touched by the digit 906, a deformation is formed in a fleshy part of the palmar surface of the hand 910 that can be detected as a hand touch at the location of the palmar user interface element 912. These interactions can be used as user inputs into an application of the XR system that is associated with the palmar hand-centric user interface 900.

In some examples, the set of palmar user interface elements are provided on a non-dominant hand of the user and the user uses one or more digits of their dominant hand to touch the palmar surface of the non-dominant hand.

In some examples, the set of palmar user interface elements are provided on a dominant hand of the user and the user uses one or more digits of their non-dominant hand to touch the palmar surface of the dominant hand.

In some examples, an XR system can be configured to display the palmar hand-centric user interface 900 on a non-dominant hand of the user by default. In other examples, an XR system can be configured to display the palmar hand-centric user interface 900 on a dominant hand of the user by default.

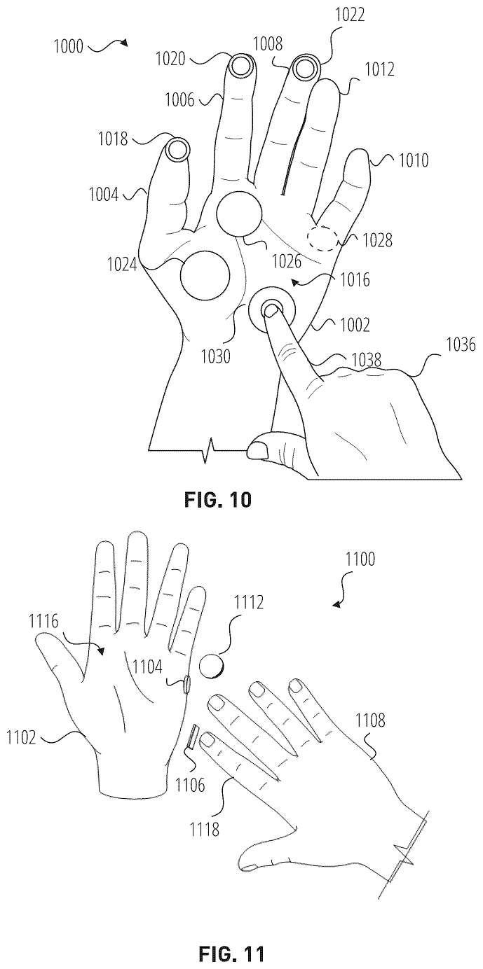

FIG. 10 illustrates another palmar hand-centric user interface 1000, according to some examples. The figure depicts a hand 1002 with its palmar surface 1016 visible. The hand 1002 is shown with five digits: thumb 1004, index finger 1006, middle finger 1008, ring finger 1012, and little finger 1010. In some examples, the palmar hand-centric user interface 1000 includes a set of user interface elements positioned on different parts of the hand 1102. A set of fingertip user interface elements are located on the fingertips of the fingers of the hand 1002, such as fingertip user interface element 1018 on the index finger 1006, fingertip user interface element 1020 on the middle finger 1008, and fingertip user interface element 1022 on the ring finger 1012.

In some examples, the user interacts with the fingertip user interface elements by making a finger pinch between the thumb 1004 and a finger to bring their respective fingertip user interface elements into contact. For example, the user can make a finger pinch between the thumb 1004 and the index finger 1006 bringing fingertip user interface element 1020 on the index finger 1006 into contact with the fingertip user interface element 1018 on the thumb 1004. As another example, the user can make a finger pinch between the thumb 1004 and the fingertip user interface element 1022 bringing fingertip user interface element 1022 on the middle finger 1008 into contact with the fingertip user interface element 1018 on the thumb 1004. In some examples, the XR system uses a hand gesture recognition model to detect when a finger pinch to bring two fingertip user interface elements together is made by the user as more fully described in reference to FIG. 6. In some examples, the XR system uses geometric methodologies to determine when a finger pinch is used to bring two fingertip user interface elements are brought into contact with each other as more fully described in reference to FIG. 6.

In some examples, a user interacts with the fingertip user interface elements with a finger tap by tapping a fingertip user interface element of a finger of the (first) hand 1002 with a fingertip of a digit 1038 of their other (second) hand 1036. In some examples, the XR system uses geometric methodologies or a hand gesture recognition model to determine when the user finger taps a fingertip user interface element using the digit 1038 of their other hand 1036 as more fully described in reference to FIG. 6.

In some examples, a set of user interface elements are located on the palmar surface 1016 such as, but not limited to, palmar user interface element 1024, palmar user interface element 1026, and palmar user interface element 1030. The user interacts with these palmar user interface elements as more fully described in reference to FIG. 9.

In some examples, the little finger 1010 has a dedicated little finger user interface element 1028 accessible by the user by bending their little finger 1010 until the fingertip of the little finger 1010 is in contact with the little finger user interface element 1028. In some examples, the XR system uses a hand gesture recognition model, a hand touch detection pipeline, or geometric technologies to detect when the fingertip of the little finger is used to make a hand touch on the palmar surface 1016 in the location of the little finger user interface element 1028.

The layout of the palmar hand-centric user interface 1000 demonstrates a strategic placement of user interface elements that takes advantage of the natural contours and easily accessible areas of the hand. The distribution of user interface elements across different parts of the hand 1002—fingertips, palm center, and palm edges-allows for a variety of interaction types and optimizes for both user comfort and interaction accuracy in an XR environment. This hand-centric user interface design leverages the user's proprioception and provides a natural, always-available surface for interaction within the XR environment.

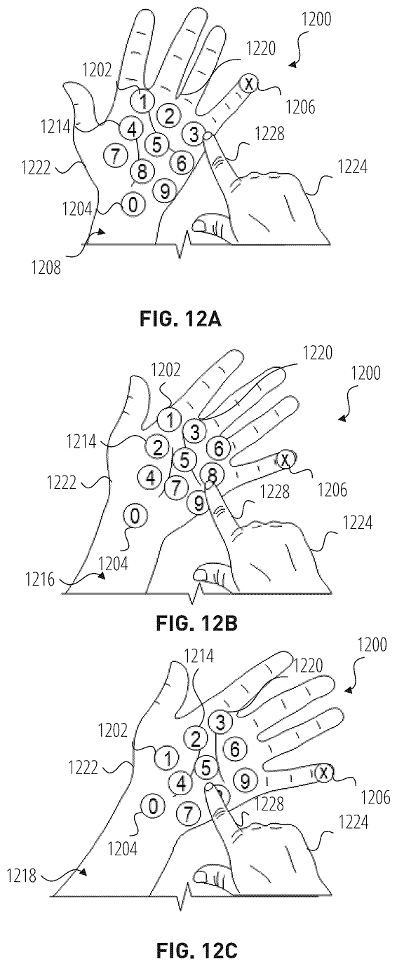

FIG. 11 is an illustration of an ulnar hand-centric user interface 1100, according to some examples. The XR system generates the ulnar hand-centric user interface 1100 for a (first) hand 1102 and the user interacts with the ulnar hand-centric user interface 1100 using another (second) hand. The hand 1102 is shown with its ulnar side (the side of the hand with the little finger) facing upward exposing the palmar surface 1116 to the view of the user. On the ulnar side of the hand 1102, there are a set of ulnar user interface elements, ulnar user interface element 1104 and ulnar user interface element 1106. These user interface elements are positioned along the edge of the hand 1102, taking advantage of the natural contours of the ulnar side of the hand 1102. In use, the user uses their other (second) hand 1108 to interact with the ulnar user interface element 1104 or the ulnar user interface element 1106 of the (first) hand 1102 using one or more digits 1118 of their other hand 1108.

In some examples, in the case of the ulnar user interface element 1104, an ulnar user interface element can be a “poke” user interface element that the user pokes or prods using the digit 1118. In some examples, the XR system can use a hand touch detection pipeline, or geometric technologies to detect when the digit 1118 is used to make a poking or prodding interaction with the ulnar user interface element 1104.

In some examples, in the case of the ulnar user interface element 1106, an ulnar user interface element can be a “push” user interface element that the user pushes using the digit 1118. In some examples, the XR system uses geometric technologies to detect when the digit 1118 is used to make a pushing interaction with the ulnar user interface element 1106.

In some examples, the ulnar hand-centric user interface 1100 can include a pinch user interface element 1112 that a user pinches or grabs using their other hand 1108. In some examples, the XR system can use geometric technologies or a hand gesture recognition model to detect when the user's other hand 1108 is used to make a pinching or grabbing interaction with the pinch user interface element 1112.

By utilizing the ulnar side of the hand, the ulnar hand-centric user interface 1100 provides additional interactive surfaces beyond the palm or dorsal side of the hand. This approach potentially allows for a wider range of interaction possibilities and may be particularly useful when the palm or back of the hand is not easily accessible or visible.

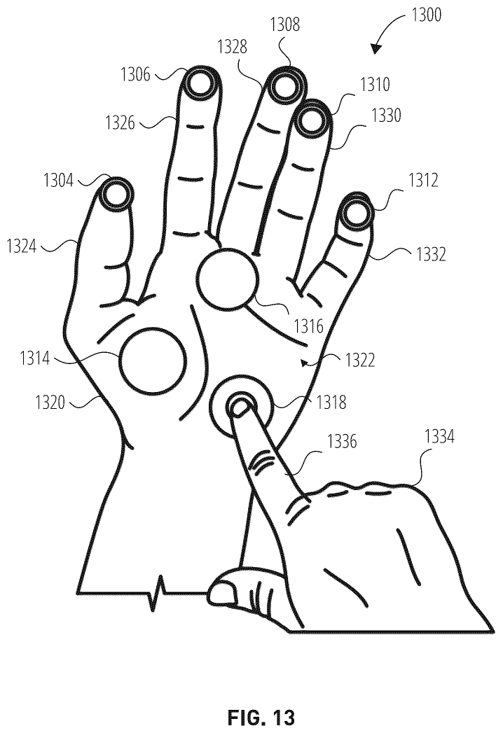

FIG. 12A is a diagram illustrating an orientation-adaptive palmar hand-centric user interface 1200, according to some examples. The adaptive hand-centric user interface 1200 is provided on a palmar surface, wrist, and one or more fingers of a hand 1222 in a vertical hand orientation 1208. The adaptive hand-centric user interface 1200 adapts to the position of the hand 1222, allowing for intuitive interaction regardless of how the user holds their hand 1222. This adaptability enhances the usability of a hand-centric user interface in various scenarios and user postures

The adaptive hand-centric user interface 1200 includes a set of user interface elements, such as palmar user interface element 1202, palmar user interface element 1220, and palm user interface element 1214. In some examples, the palmar user interface elements are arranged on the palmar surface of the hand 1222 in a numerical keypad layout. The palmar user interface elements are numbered from 1 to 9. A wrist user interface element 1204 is numbered 0. A finger user interface element 1206, is labeled ‘X’ representing a delete or cancel function.

In some examples, the palmar user interface elements corresponding to the numerals 1 to 9 are positioned in a 3×3 grid pattern with the wrist user interface element 1204 corresponding to ‘0’ element placed below on the wrist of the hand 1222, similar to a keypad layout.

To interact with the adaptive hand-centric user interface 1200 the user uses a digit 1228 of their other (second) hand 1224 to interact with the user interface elements located on the (first) hand 1222. For example, the XR system can detect the user's interactions with the wrist user interface element 1204, the palmar user interface elements and the wrist user interface element 1204 using a hand touch. The user can interact with the finger user interface element 1206 using a finger tap. In some examples, the XR system can use a hand touch detection pipeline or geometric methodologies to detect a hand touch as more fully described in reference to FIG. 6. In some examples, the XR system can use a hand gesture recognition model or geometric methodologies to detect a finger tap as more fully described in reference to FIG. 6.

FIG. 12B is a diagram illustrating an orientation-adaptive palmar hand-centric user interface 1200 for a diagonal hand orientation 1216, according to some examples.

The figure depicts a hand 1222 with its palmar surface visible, showing a diagonal hand orientation 1216. As the orientation of the hand 1222 changes, the XR system adapts the adaptive hand-centric user interface 1200 to better fit the hand 1222 and to maintain user comfort as the user interacts with the adaptive hand-centric user interface 1200.

In some examples, the user interface elements, such as palmar user interface element 1202, palm user interface element 1214, and palmar user interface element 1220, and wrist user interface element 1204 maintain a numerical keypad layout as in FIG. 12A, but the positions of the set of palmar user interface elements are shifted to accommodate the diagonal hand orientation 1216. The palmar user interface elements representing numerals 1 to 9 are still arranged in a 3×3 grid pattern with the wrist user interface element 1204 representing ‘0’ located on the wrist and below the 3×3 grid pattern, similar to a keypad layout.

FIG. 12C is a diagram illustrating an orientation-adaptive palmar hand-centric user interface 1200 for a horizontal hand orientation 1218, according to some examples. In some examples, the user interface elements in FIG. 12C maintain the same numerical keypad layout as in FIG. 12B and FIG. 12A, but the positions of the set of palmar user interface elements and the wrist user interface element 1204 have shifted to accommodate the horizontal hand orientation 1218 of the hand 1222. The palmar user interface elements are still arranged in a 3×3 grid pattern with the wrist user interface element 1204 located on the wrist of the hand 1222, similar to a keypad layout.

In some examples, the XR system maintains the icons on the set of user interface elements in an invariant orientation in relation to a user frame of reference as the user positions their hand 1222 in various orientations relative to a user frame of reference. For example, an orientation of the icons representing the numerals 0 to 9 and the character ‘X’ are maintained in an invariant vertical orientation in relation to the user frame of reference regardless of a hand orientation such as vertical hand orientation 1208, diagonal hand orientation 1216, and horizontal hand orientation 1218, as illustrated in FIG. 12A, FIG. 12B, and FIG. 12C, respectively. This invariant orientation of the icons relative to the user's frame of reference ensures that the adaptive hand-centric user interface 1200 remains consistent and easily readable, regardless of how the user holds or moves their hand 1222. The XR system achieves this by dynamically adjusting the rendering of the user interface elements on the palmar surface, wrist, and fingers of the user's hand to compensate for the changing position and orientation of the hand 1222, maintaining a stable and intuitive interface for the user.

In some examples, an ordering of the numerals on the set of palmar user interface elements is changed in accordance with the orientation of the hand 1222. For example, the XR system adapts the ordering of the numerals on the set of palmar user interface elements based on the detected orientation of the hand 1222. As shown in FIG. 12A, FIG. 12B, and FIG. 12C, the numerical keypad layout maintains the same overall arrangement of palmar user interface elements in a 3×3 grid pattern with the ‘0’ wrist user interface element 1204 placed below on a wrist of the hand 1222, similar to a keypad layout. However, the positions of the individual palmar user interface elements corresponding to the numerals 1 to 9 shift to accommodate the changing hand orientation, from vertical in FIG. 12A, to diagonal in FIG. 12B, to horizontal in FIG. 12C. This adaptive adjustment of the numeral ordering ensures that the adaptive hand-centric user interface 1200 remains usable and intuitive regardless of how the user holds their hand.

The adaptive layout of the adaptive hand-centric user interface 1200 provides a strategic placement of user interface elements that takes advantage of the natural contours and easily accessible areas of the hand. The distribution of user interface elements across different parts of the hand, wrist, and fingers allows for a variety of interaction types and optimizes for both user comfort and interaction accuracy.

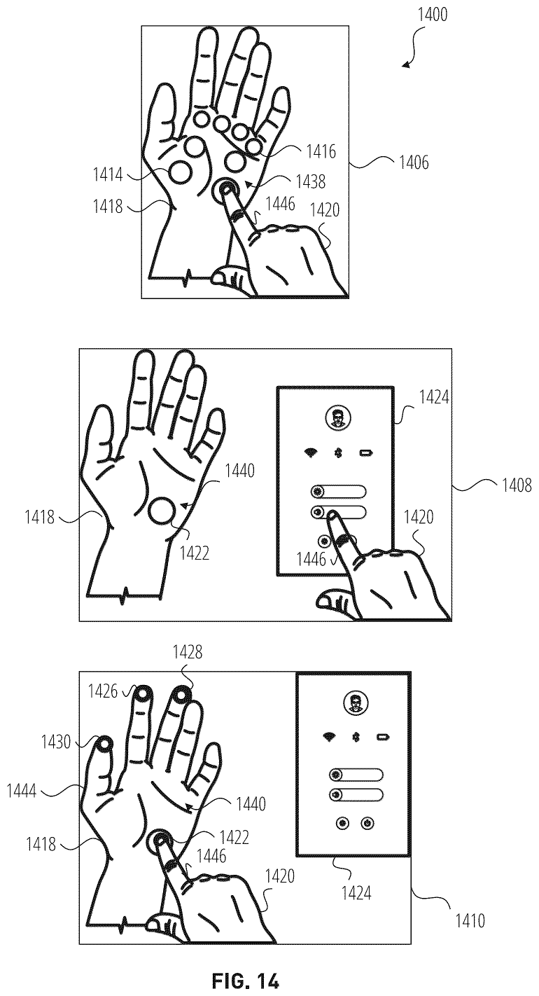

FIG. 13 is a diagram illustrating another palmar hand-centric user interface 1300, according to some examples. The figure depicts a hand 1320 of a user with a palmar surface 1322 facing the user, showing a set of user interface elements positioned on different parts of the hand 1320.

Each fingertip of the digits of the hand 1320 includes a fingertip user interface element of the set of user interface elements, such as fingertip user interface element 1304 on the thumb 1324, fingertip user interface element 1306 on the index finger 1326, fingertip user interface element 1308 on the middle finger 1328, fingertip user interface element 1310 on the ring ringer finger 1330, and fingertip user interface element 1312 on the little finger 1332.

On the palmar surface 1322 of the hand 1320, there are a set of palmar user interface elements positioned at different locations on the palmar surface 1322. These include palmar user interface element 1314 near the base of the thumb, palmar user interface element 1316 above a center of the palmar surface 1322, and palmar user interface element 1318 near the base of the little finger 1332. In some examples, the set of palmar user interface elements can include 1 to 5 palmar user interface elements. In some examples, the set of palmar user interface elements includes 6 or more palmar user interface elements.

In some examples, to interact with the fingertip user interface elements, the user uses a finger pinch between the fingertip user interface element 1304 of the thumb 1324 with a fingertip user interface element of a finger, such as fingertip user interface element 1306 of index finger 1326, fingertip user interface element 1308 of middle finger 1328, fingertip user interface element 1310 of ringer finger 1330, and fingertip user interface element 1312 of little finger 1332. In some examples, the XR system can detect a finger pinch using a hand gesture recognition model or geometric methodologies as more fully described in reference to FIG. 6.

In some examples, to interact with the fingertip user interface elements, the user uses a digit 1336 of their other (second) hand 1334 to perform a finger tap on a fingertip user interface element located on the (first) hand 1320. In some examples, the XR system can detect a finger tap using geometric methodologies or a hand gesture recognition model as more fully described in reference to FIG. 6.

In some examples, to interact with a palmar user interface element such as palmar user interface element 1314, palmar user interface element 1316, or palmar user interface element 1318, the user uses a digit 1336 of their other (second) hand 1334 to perform a hand touch at a location of a palmar user interface element on the palmar surface 1322 of the (first) hand 1320. In some examples, the XR system can use geometric methodologies or a hand touch detection pipeline to detect a hand touch as more fully described in reference to FIG. 6.

In reference to FIG. 7, in operation 708, the XR system detects, using the set of tracking sensors, a user input based on an interaction with the hand-centric user interface. For example, The XR system captures images including images of one or both of the user's hands. The XR system uses one or more cameras included in a set of tracking sensors of the XR system to capture tracking data. The tracking data includes images of the hands of the user as the user interacts with the hand-centric user interface. In some examples, the XR system uses a hand touch detector to detect a hand touch of a surface of the (first) hand associated with the hand-centric user interface by a digit of another (second) hand of the user as previously described herein.

In operation 710, hand-centric user interface method 700 performs an action in the XR system based on the user input. For example, the XR system provides the detected hand touch of the surface of the hand of the user as an input into an application associated with the hand-centric user interface. In some examples, hand touch data including data of the hand touch by the digit of the user to the surface of the hand is communicated to the user interface engine by a hand touch detection pipeline. Simultaneously, 3D tracking data including data of a 3D location of the hand including the surface of the (first) hand being touched, and the digit of another (second) hand is communicated to the user interface engine by a tracking pipeline. The user interface engine receives the hand touch data from the hand touch detection pipeline and the 3D tracking data from the tracking pipeline. The user interface engine uses the data of the hand touch to the surface of the hand, the data of the 3D location of the hand including the surface, and the data of the 3D location of a set of user interface elements included in the hand-centric user interface stored in a user interface object model to determine if the user has touched their hand at a location on the surface that corresponds to a location of one or more of the user interface elements of the set of user interface elements. In response to determining that the user has touched the surface of their hand at a location that corresponds to a location of one or more of the set of user interface elements, the user interface engine determines that the user has selected and is interacting with the determined one or more of the user interface elements of the set of user interface elements. The XR system performs a function or action associated with the application of the hand-centric user interface using the determined one or more of the user interface elements of the set of user interface elements as user input.

In some examples, an XR system uses dorsal hand-centric user interfaces for supplying system information to a user and accepting inputs of system settings from the user and uses palmar hand-centric user interfaces for application user interfaces of a more general nature. For example, the XR system implements different types of hand-centric user interfaces for distinct purposes. The dorsal hand-centric user interface, displayed on the back of the hand, is utilized for providing system information and accepting system setting inputs from the user. This is exemplified in FIG. 8, which shows a dorsal hand-centric user interface 800 with components like a status watch 830, network status icon 832, and battery level icon 834 for displaying system information. The dorsal surface also includes user interface elements 838, 840, and 842 that can be used for inputting system settings.

The XR system employs palmar hand-centric user interfaces, displayed on the palm side of the hand, for more general application user interfaces. This is illustrated in FIG. 9, which depicts a palmar hand-centric user interface 900 with various palmar user interface elements 912, 914, 916, and 918 that can be used for interacting with different applications or functions within the XR environment. The palmar surface provides a larger, more versatile area for displaying and interacting with a wider range of application-specific interfaces.

This differentiation allows the XR system to optimize the use of available hand surfaces, leveraging the dorsal side for quick access to system information and settings, while reserving the more spacious and easily accessible palm area for diverse application interfaces

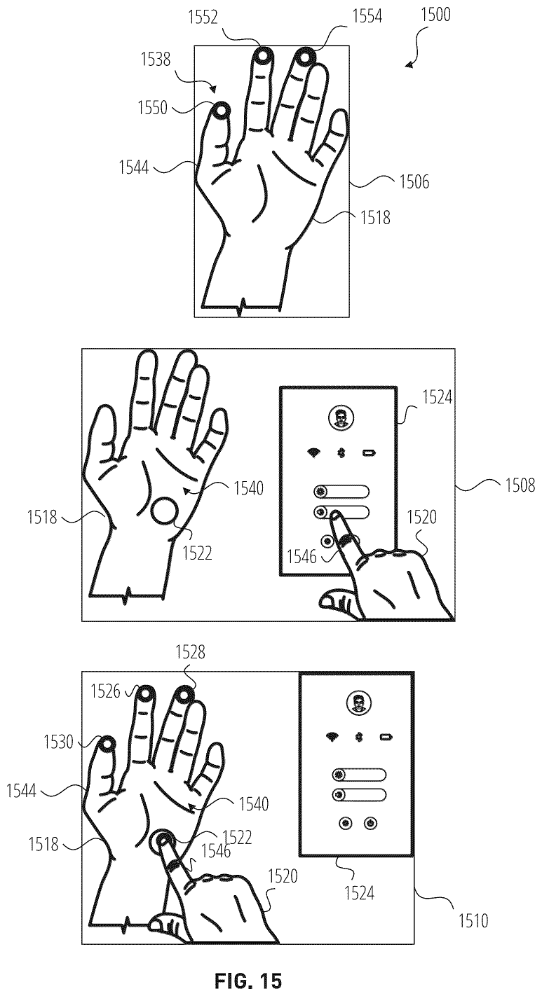

FIG. 14 is a diagram illustrating an in-application system user interface sequence 1400, according to some examples. An XR system uses the in-application system user interface sequence 1400 to provide an in-application hand-centric system user interface 1440 to a user of the XR system. This approach allows for intuitive, always-available access to both system and application functions within the XR environment.

In a first state 1406, the XR system causes a display of a hand-centric system user interface 1438 on a palmar surface of a hand 1418 of the user. The hand-centric system user interface 1438 includes a set of user interface elements including a subset of system palmar user interface elements, such as system palmar user interface element 1414, that a user may select to perform various system level functions. The set of user interface elements can include a subset of application palmar user interface elements, such as application palmar user interface element 1416, that a user can use to invoke one or more applications of the XR system directly from the hand-centric system user interface 1438. The user uses a digit 1446 of their other (second) hand 1420 to interact with the system palmar user interface elements and the application palmar user interface elements located on the (first) hand 1418 using a hand touch to touch a location of the palmar surface at a location of a system palmar user interface element or an application palmar user interface element. In some examples, the XR system can use geometric methodologies or a hand touch detection pipeline to detect a hand touch as more fully described in reference to FIG. 6.

In a second state 1408, entered when the user invokes an application, the XR system causes display of an in-application hand-centric system user interface 1440 and a floating application user interface 1424 of the invoked application to the user. The in-application hand-centric system user interface 1440 includes a system palmar user interface element 1422 provided on the palmar surface of the hand 1418. The user uses the system palmar user interface element 1422 to access system level functions while using the application providing the floating application user interface 1424. The user uses their other hand 1420 to interact with the floating application user interface 1424.

A third state 1410 is entered when the user uses their other hand 1420 to select system palmar user interface element 1422 using a hand touch while using the application associated with the floating application user interface 1424. In the third state 1410, the XR system causes display of an in-application hand-centric system user interface 1440 including system fingertip user interface element 1430, system fingertip user interface element 1426, system fingertip user interface element 1428. The fingertip user interface elements provide system level functions such as, but not limited to, exiting the application, access to a settings user interface, and the like.

In some examples, the user interacts with a fingertip user interface element using a finger pinch between a thumb 1444 and the finger associated with the fingertip user interface element. In some examples, the XR system can detect a finger pinch using a hand gesture recognition model or geometric methodologies as more fully described in reference to FIG. 6.

In some examples, to interact with the fingertip user interface elements, the user uses a digit 1446 of their other (second) hand 1420 to perform a finger tap on a fingertip user interface element located on the (first) hand 1418. In some examples, the XR system can detect a finger tap using geometric methodologies or a hand gesture recognition model as more fully described in reference to FIG. 6.

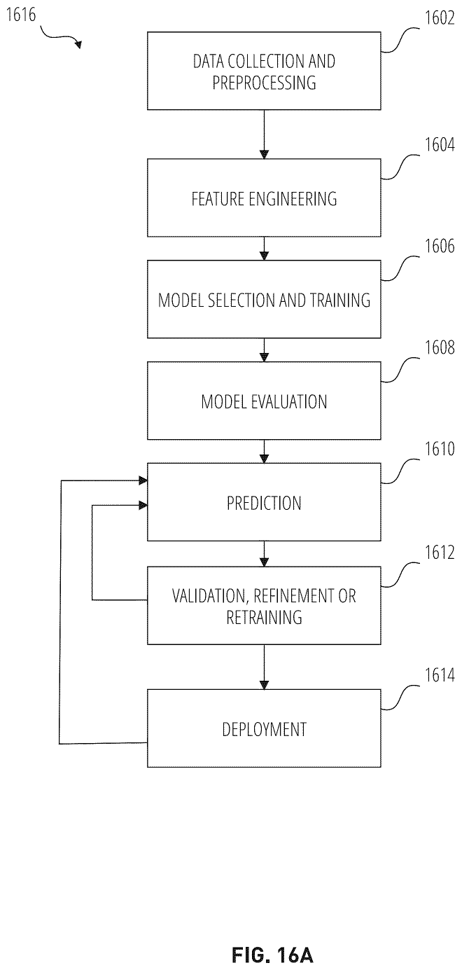

FIG. 15 is a diagram illustrating another in-application system user interface sequence 1500, according to some examples. An XR system uses the in-application system user interface sequence 1500 to provide an in-application hand-centric system user interface 1540 to a user of the XR system.

In a first state 1506, the XR system causes a display of a hand-centric system user interface 1538 on a hand 1518 of the user. The hand-centric system user interface 1538 includes a set of user interface elements including fingertip user interface element 1550, fingertip user interface element 1552, and fingertip user interface element 1554 that a user may select to perform various system level functions. The system level functions can include, but are not limited to, invoking an application selection user interface that a user can use to open an application, invoking a system explorer that a user can use to find resources such as settings user interfaces, and the like.

In some examples, the user interacts with a fingertip user interface element of the using a finger pinch between a thumb 1544 and the finger associated with the fingertip user interface element. In some examples, the XR system can detect a finger pinch using a hand gesture recognition model or geometric methodologies as more fully described in reference to FIG. 6.

In some examples, to interact with the fingertip user interface elements of the hand-centric system user interface 1538, the user uses a digit of their other (second) hand to perform a finger tap on a fingertip user interface element located on the (first) hand 1518. In some examples, the XR system can detect a finger tap using geometric methodologies or a hand gesture recognition model as more fully described in reference to FIG. 6.

In a second state 1508, entered when the user invokes an application, the XR hand-centric causes display of an in-application hand-centric system user interface 1540 and a floating application user interface 1524 of the invoked application to the user. The in-application hand-centric system user interface 1540 includes a system palmar user interface element 1522 provided on the palmar surface of the hand 1518. The user uses the system palmar user interface element 1522 to access system level functions while using the application providing the floating application user interface 1524. The user uses their other hand 1520 to interact with the floating application user interface 1524.

A third state 1510 is entered when the user uses their other hand 1520 to select system palmar user interface element 1522 using a hand touch while using the application associated with the floating application user interface 1524. In the third state 1510, the XR system causes display of an in-application hand-centric system user interface 1540 including system fingertip user interface element 1530, system fingertip user interface element 1526, system fingertip user interface element 1528. The fingertip user interface elements provide system level functions such as, but not limited to, exiting the application, access to a settings user interface, and the like.

In some examples, the user interacts with a fingertip user interface element using a finger pinch between a thumb 1544 and the finger associated with the fingertip user interface element. In some examples, the XR system can detect a finger pinch using a hand gesture recognition model or geometric methodologies as more fully described in reference to FIG. 6.

In some examples, to interact with the fingertip user interface elements, the user uses a digit 1546 of their other (second) hand 1520 to perform a finger tap on a fingertip user interface element located on the (first) hand 1518. In some examples, the XR system can detect a finger tap using geometric methodologies or a hand gesture recognition model as more fully described in reference to FIG. 6.

### Machine-Learning Pipeline

FIG. 16B is a flowchart depicting a machine-learning pipeline 1616, according to some examples. The machine-learning pipeline 1616 can be used to generate a trained machine-learning model 1618 such as, but not limited to, a hand gesture recognition model, speech recognition model 684 of FIG. 6, ROI detector model 609 of FIG. 6, tracking model 644 of FIG. 6, 3D coordinate generator model 646 of FIG. 6, cropping model 662 of FIG. 6, hand touch model 660 of FIG. 6, and the like, to perform operations associated with determining user inputs into an XR system, such as XR system 610 of FIG. 6.

Machine learning can involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that can be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting can be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

Generating a trained machine-learning model 1618 can include multiple phases that form part of the machine-learning pipeline 1616, including for example the following phases illustrated in FIG. 16A:
Data collection and preprocessing 1602: This phase can include acquiring and cleaning data to ensure that it is suitable for use in the machine learning model. This phase can also include removing duplicates, handling missing values, and converting data into a suitable format.
Feature engineering 1604: This phase can include selecting and transforming the training data 1622 to create features that are useful for predicting the target variable. Feature engineering can include (1) receiving features 1624 (e.g., as structured or labeled data in supervised learning) and/or (2) identifying features 1624 (e.g., unstructured or unlabeled data for unsupervised learning) in training data 1622.
Model selection and training 1606: This phase can include selecting an appropriate machine learning algorithm and training it on the preprocessed data. This phase can further involve splitting the data into training and testing sets, using cross-validation to evaluate the model, and tuning hyperparameters to improve performance.
Model evaluation 1608: This phase can include evaluating the performance of a trained model (e.g., the trained machine-learning model 1618) on a separate testing dataset. This phase can help determine if the model is overfitting or underfitting and determine whether the model is suitable for deployment.
Prediction 1610: This phase involves using a trained model (e.g., trained machine-learning model 1618) to generate predictions on new, unseen data.
Validation, refinement or retraining 1612: This phase can include updating a model based on feedback generated from the prediction phase, such as new data or user feedback.
Deployment 1614: This phase can include integrating the trained model (e.g., the trained machine-learning model 1618) into a more extensive system or application, such as a web service, mobile app, or IoT device. This phase can involve setting up APIs, building a user interface, and ensuring that the model is scalable and can handle large volumes of data.

FIG. 16B illustrates further details of two example phases, namely a training phase 1620 (e.g., part of the model selection and trainings 1606) and a prediction phase 1626 (part of prediction 1610). Prior to the training phase 1620, feature engineering 1604 is used to identify features 1624. This can include identifying informative, discriminating, and independent features for effectively operating the trained machine-learning model 1618 in pattern recognition, classification, and regression. In some examples, the training data 1622 includes labeled data, known for pre-identified features 1624 and one or more outcomes. Each of the features 1624 can be a variable or attribute, such as an individual measurable property of a process, article, system, or phenomenon represented by a data set (e.g., the training data 1622). Features 1624 can also be of different types, such as numeric features, strings, and graphs, and can include one or more of content 1628, concepts 1630, attributes 1632, historical data 1634, and/or user data 1636, merely for example.

In training phase 1620, the machine-learning pipeline 1616 uses the training data 1622 to find correlations among the features 1624 that affect a predicted outcome or prediction/inference data 1638.

With the training data 1622 and the identified features 1624, the trained machine-learning model 1618 is trained during the training phase 1620 during machine-learning program training 1640. The machine-learning program training 1640 appraises values of the features 1624 as they correlate to the training data 1622. The result of the training is the trained machine-learning model 1618 (e.g., a trained or learned model).

Further, the training phase 1620 can involve machine learning, in which the training data 1622 is structured (e.g., labeled during preprocessing operations). The trained machine-learning model 1618 implements a neural network 1642 capable of performing, for example, classification and clustering operations. In other examples, the training phase 1620 can involve deep learning, in which the training data 1622 is unstructured, and the trained machine-learning model 1618 implements a deep neural network 1642 that can perform both feature extraction and classification/clustering operations.

In some examples, a neural network 1642 can be generated during the training phase 1620, and implemented within the trained machine-learning model 1618. The neural network 1642 includes a hierarchical (e.g., layered) organization of neurons, with each layer consisting of multiple neurons or nodes. Neurons in the input layer receive the input data, while neurons in the output layer produce the final output of the network. Between the input and output layers, there can be one or more hidden layers, each consisting of multiple neurons.

Each neuron in the neural network 1642 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks can use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 1642 can also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1620, a validation phase can be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model can be tested on a new dataset. The testing dataset is used to evaluate the model's performance and ensure that the model has not overfitted the training data.

In prediction phase 1626, the trained machine-learning model 1618 uses the features 1624 for analyzing inference data 1644 to generate inferences, outcomes, or predictions, as examples of a prediction/inference data 1638. For example, during prediction phase 1626, the trained machine-learning model 1618 generates an output. Inference data 1644 is provided as an input to the trained machine-learning model 1618, and the trained machine-learning model 1618 generates the prediction/inference data 1638 as output, responsive to receipt of the inference data 1644.

In some examples, the trained machine-learning model 1618 can be a generative AI model. Generative AI is a term that can refer to any type of artificial intelligence that can create new content from training data 1622. For example, generative AI can produce text, images, video, audio, code, or synthetic data similar to the original data but not identical. In cases where the trained machine-learning model 1618 is a generative AI, inference data 1644 can include text, audio, image, video, numeric, or media content prompts and the output prediction/inference data 1638 can include text, images, video, audio, code, or synthetic data.

Some of the Techniques that can be Used in Generative AI are:
Convolutional Neural Networks (CNNs): CNNs can be used for image recognition and computer vision tasks. CNNs can, for example, be designed to extract features from images by using filters or kernels that scan the input image and highlight important patterns.
Recurrent Neural Networks (RNNs): RNNs can be used for processing sequential data, such as speech, text, and time series data, for example. RNNs employ feedback loops that allow them to capture temporal dependencies and remember past inputs.
Generative adversarial networks (GANs): GANs can include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs can encode input data into a latent space (e.g., a compressed representation) and then decode it back into output data. The latent space can be manipulated to generate new variations of the output data. VAEs can use self-attention mechanisms to process input data, allowing them to handle long text sequences and capture complex dependencies.
Transformer models: Transformer models can use attention mechanisms to learn the relationships between different parts of input data (such as words or pixels) and generate output data based on these relationships. Transformer models can handle sequential data, such as text or speech, as well as non-sequential data, such as images or code.

Described implementations of the subject matter can include one or more features, alone or in combination as illustrated below by way of example:

Example 1 is a machine-implemented method for providing a user interface in an XR system, the method comprising: detecting, using a set of tracking sensors of the XR system, a position and an orientation of a hand of a user; determining a surface of the hand facing the user; in response to determining a dorsal surface of the hand is facing the user, causing display of a hand-centric user interface using a set of dorsal surface user interface elements; in response to determining a palmar surface of the hand is facing the user, causing display of the hand-centric user interface using a set of palmar user interface elements; detecting, using the set of tracking sensors, a user input based on an interaction with the hand-centric user interface; and performing an action in the XR system based on the user input.

In Example 2, the subject matter of Example 1 includes, wherein causing display of the hand-centric user interface comprises: generating a three-dimensional (3D) mesh of the hand based on the detected position and orientation; dynamically rendering a set of user interface elements as a texture; applying the rendered texture to the 3D mesh of the hand to display the hand-centric user interface.

In Example 3, the subject matter of any of Examples 1-2 includes, wherein applying the rendered texture to the 3D mesh comprises using UV mapping to wrap the texture around the 3D mesh of the hand.

In Example 4, the subject matter of any of Examples 1-3 includes, detecting a change in the position or the orientation of the hand of the user; and dynamically updating the rendered texture on the 3D mesh to maintain the hand-centric user interface in response to the detected change.

In Example 5, the subject matter of any of Examples 1-4 includes, wherein the interaction comprises at least one of a finger pinch, a hand touch, or a finger tap.

In Example 6, the subject matter of any of Examples 1-5 includes, wherein the hand-centric user interface is configured for interactions using another hand of the user.

In Example 7, the subject matter of any of Examples 1-6 includes, wherein the XR system is a head-wearable apparatus.

Example 8 is at least one machine-readable medium including instructions that, when executed by processing circuitry, cause the processing circuitry to perform operations to implement any of Examples 1-7.

Example 9 is an apparatus comprising means to implement any of Examples 1-7.

Example 10 is a system to implement any of Examples 1-7.

The various features, operations, or processes described herein can be used independently of one another, or can be combined in various ways. All possible combinations and sub-combinations are intended to fall within the scope of this disclosure. In addition, certain method or process blocks can be omitted in some implementations.

Although some examples, e.g., those depicted in the drawings, include a particular sequence of operations, the sequence can be altered without departing from the scope of the present disclosure. For example, some of the operations depicted can be performed in parallel or in a different sequence that does not materially affect the functions as described in the examples. In other examples, different components of an example device or system that implements an example method can perform functions at substantially the same time or in a specific sequence.

Changes and modifications can be made to the disclosed examples without departing from the scope of the present disclosure. These and other changes or modifications are intended to be included within the scope of the present disclosure, as expressed in the appended claims.

### TERM EXAMPLES

As used in this disclosure, phrases of the form “at least one of an A, a B, or a C,” “at least one of A, B, or C,” “at least one of A, B, and C,” and the like, should be interpreted to select at least one from the group that includes “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” “include,” “including,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number can also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

“Carrier signal” can include, for example, any intangible medium that can store, encoding, or carrying instructions for execution by the machine and includes digital or analog communications signals or other intangible media to facilitate communication of such instructions. Instructions can be transmitted or received over a network using a transmission medium via a network interface device.

“Client device” can include, for example, any machine that interfaces to a network to obtain resources from one or more server systems or other client devices. A client device can be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user can use to access a network.

“Component” can include, for example, a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function of related functions. Components can constitute either software components (e.g., code embodied on a machine-readable medium) or hardware components. A “hardware component” is a tangible unit capable of performing certain operations and can be configured or arranged in a certain physical manner. In various examples, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein. A hardware component can also be implemented mechanically, electronically, or any suitable combination thereof. For example, a hardware component can include dedicated circuitry or logic that is permanently configured to perform certain operations. A hardware component can be a special-purpose processor, such as a field-programmable gate array (FPGA) or an application-specific integrated circuit (ASIC). A hardware component can also include programmable logic or circuitry that is temporarily configured by software to perform certain operations. For example, a hardware component can include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), can be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component includes a general-purpose processor configured by software to become a special-purpose processor, the general-purpose processor can be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output. Hardware components can also initiate communications with input or output devices, and can operate on a resource (e.g., a collection of information). The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions described herein. As used herein, “processor-implemented component” can refer to a hardware component implemented using one or more processors. Similarly, the methods described herein can be at least partially processor-implemented, with a particular processor or processors being an example of hardware. For example, at least some of the operations of a method can be performed by one or more processors or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API). The performance of certain of the operations can be distributed among the processors, not only residing within a single machine, but deployed across a number of machines. In some examples, the processors or processor-implemented components can be located in a single geographic location (e.g., within a home environment, an office environment, or a server farm). In other examples, the processors or processor-implemented components can be distributed across a number of geographic locations.

“Computer-readable medium” can include, for example, both machine-storage media and signal media. Thus, the terms include both storage devices/media and carrier waves/modulated data signals. The terms “machine-readable medium,” “computer-readable medium” and “device-readable medium” mean the same thing and can be used interchangeably in this disclosure.

“Machine-storage medium” can include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine-storage medium can also refer to cloud storage services, Network Attached Storage (NAS), Storage Area Networks (SAN), and object storage devices. The terms “machine-storage medium,” “device-storage medium,” “computer-storage medium” mean the same thing and can be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” can include, for example, one or more portions of a network that can be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network can include a wireless or cellular network, and the coupling can be a Code Division Multiple Access (CDMA) connection, a Global System for Mobile communications (GSM) connection, or other types of cellular or wireless coupling. In this example, the coupling can implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable medium” can include, for example, a tangible medium that is capable of storing, encoding, or carrying the instructions for execution by a machine.

“Processor” can include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” can include multi-core processors that can include two or more independent processors (sometimes referred to as “cores”) that can execute instructions contemporaneously. These cores can be homogeneous (e.g., all cores are identical, as in multicore CPUs) or heterogeneous (e.g., cores are not identical, as in many modern GPUs and some CPUs). In addition, the term “processor” can also encompass systems with a distributed architecture, where multiple processors are interconnected to perform tasks in a coordinated manner. This includes cluster computing, grid computing, and cloud computing infrastructures. Furthermore, the processor can be embedded in a device to control specific functions of that device, such as in an embedded system, or it can be part of a larger system, such as a server in a data center. The processor can also be virtualized in a software-defined infrastructure, where the processor's functions are emulated in software.

“Signal medium” can include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and can be used interchangeably in this disclosure.

“User device” can include, for example, a device accessed, controlled or owned by a user and with which the user interacts perform an action, engagement or interaction on the user device, including an interaction with other users or computer systems.

What is claimed is:

1. A machine-implemented method comprising:
detecting, using a set of tracking sensors of an extended Reality (XR) system, a position and an orientation of a hand of a user;
determining a surface of the hand facing the user using the position and orientation of the hand;
selectively causing display of a hand-centric user interface based on whether the surface of the hand facing the user is a dorsal surface of the hand or a palmar surface of the hand;
detecting, using the set of tracking sensors, a user input based on an interaction with the hand-centric user interface; and
performing an action in the XR system based on the user input.

2. The machine-implemented method of claim 1, wherein causing display of the hand-centric user interface comprises:
generating a three-dimensional (3D) mesh of the hand based on the detected position and orientation;
dynamically rendering a set of user interface elements as a texture;
applying the rendered texture to the 3D mesh of the hand to display the hand-centric user interface.

3. The machine-implemented method of claim 2, wherein applying the rendered texture to the 3D mesh comprises using UV mapping to wrap the texture around the 3D mesh of the hand.

4. The machine-implemented method of claim 2, further comprising:
detecting a change in the position or the orientation of the hand of the user; and
dynamically updating the rendered texture on the 3D mesh to maintain the hand-centric user interface in response to the detected change.

5. The machine-implemented method of claim 1, wherein the interaction comprises at least one of a finger pinch, a hand touch, or a finger tap.

6. The machine-implemented method of claim 1, wherein the hand-centric user interface is configured for interactions using another hand of the user.

7. The machine-implemented method of claim 1, wherein the XR system is a head-wearable apparatus.

8. A machine comprising:
at least one processor; and
at least one memory storing instructions that, when executed by the at least one processor, cause the machine to perform operations comprising:
detecting, using a set of tracking sensors of an extended Reality (XR) system, a position and an orientation of a hand of a user;
determining a surface of the hand facing the user using the position and orientation of the hand;
selectively causing display of a hand-centric user interface based on whether the surface of the hand facing the user is a dorsal surface of the hand or a palmar surface of the hand;
detecting, using the set of tracking sensors, a user input based on an interaction with the hand-centric user interface; and
performing an action in the XR system based on the user input.

9. The machine of claim 8, wherein causing display of the hand-centric user interface comprises:
generating a three-dimensional (3D) mesh of the hand based on the detected position and orientation;
dynamically rendering a set of user interface elements as a texture;
applying the rendered texture to the 3D mesh of the hand to display the hand-centric user interface.

10. The machine of claim 9, wherein applying the rendered texture to the 3D mesh comprises using UV mapping to wrap the texture around the 3D mesh of the hand.

11. The machine of claim 9, wherein the operations further comprise:
detecting a change in the position or the orientation of the hand of the user; and
dynamically updating the rendered texture on the 3D mesh to maintain the hand-centric user interface in response to the detected change.

12. The machine of claim 8, wherein the interaction comprises at least one of a finger pinch, a hand touch, or a finger tap.

13. The machine of claim 8, wherein the hand-centric user interface is configured for interactions using another hand of the user.

14. The machine of claim 8, wherein the XR system is a head-wearable apparatus.

15. A machine-storage medium, the machine-storage medium including instructions that, when executed by a machine, cause the machine to perform operations comprising:
detecting, using a set of tracking sensors of an extended Reality (XR) system, a position and an orientation of a hand of a user;
determining a surface of the hand facing the user using the position and orientation of the hand;
selectively causing display of a hand-centric user interface based on whether the surface of the hand facing the user is a dorsal surface of the hand or a palmar surface of the hand;
detecting, using the set of tracking sensors, a user input based on an interaction with the hand-centric user interface; and
performing an action in the XR system based on the user input.

16. The machine-storage medium of claim 15, wherein causing display of the hand-centric user interface comprises:
generating a three-dimensional (3D) mesh of the hand based on the detected position and orientation;
dynamically rendering a set of user interface elements as a texture;
applying the rendered texture to the 3D mesh of the hand to display the hand-centric user interface.

17. The machine-storage medium of claim 16, wherein applying the rendered texture to the 3D mesh comprises using UV mapping to wrap the texture around the 3D mesh of the hand.

18. The machine-storage medium of claim 16, wherein the operations further comprise:
detecting a change in the position or the orientation of the hand of the user; and
dynamically updating the rendered texture on the 3D mesh to maintain the hand-centric user interface in response to the detected change.

19. The machine-storage medium of claim 15, wherein the interaction comprises at least one of a finger pinch, a hand touch, or a finger tap.

20. The machine-storage medium of claim 15, wherein the hand-centric user interface is configured for interactions using another hand of the user.
